(19) United States
(12) Patent Application Publication
(10) Pub. No.: US 2012/0278759 A1
(43) Pub. Date: Nov. 1, 2012

(54) INTEGRATION SYSTEM FOR MEDICAL INSTRUMENTS WITH REMOTE CONTROL

(75) Inventors: Douglas D. Curl, Norfolk, MA (US); Jeremy Wiggins, Mill Creek, WA (US)

(73) Assignee: Carrot Medical LLC, Waltham, MA (US)

(21) Appl. No.: 13/465,561

(22) Filed: May 7, 2012

Related U.S. Application Data
(63) Continuation-in-part of application No. 12/437,354, filed on May 7, 2009.
(60) Provisional application No. 61/051,331, filed on May 7, 2008.
(60) Provisional application No. 61/166,204, filed on Apr. 2, 2009.

(51) Int. Cl. G06F 3/048; G06F 3/041

(52) U.S. Cl. 715/804; 715/781; 715/863; 345/173

(57) ABSTRACT

In some aspects, the present disclosure is directed to a method. The method may include receiving, by a first computing device, a wireless signal associated with a second computing device. The method may include determining, by the first computing device, an identifier of the second computing device based at least in part on information in the wireless signal. The method may include determining, by the first computing device, based at least in part on the identifier of the second computing device, a window in a display configuration, the window configured to display data from the second computing device. The method may include receiving, by the first computing device, the data from the second computing device. The method may include displaying, by the first computing device, the data in the window in the display configuration.

### CROSS-REFERENCE TO RELATED U.S. APPLICATIONS

The present application is a continuation-in-part of U.S. application Ser. No. 12/437,354, entitled “Integration System for Medical Instruments with Remote Control” filed on May 7, 2009, which is hereby incorporated by reference in its entirety, and which claims priority to U.S. Provisional Application No. 61/051,331, entitled “Integration System for Medical Instruments” and filed on May 7, 2008, and U.S. Provisional Application No. 61/166,204, entitled “Integration System for Medical Instruments with Remote Control” and filed on Apr. 2, 2009, which are both hereby incorporated by reference in their entirety.

### FIELD

This patent application generally relates to integration of electronic instrumentation, data display, data handling, audio signals and remote control for certain medical and non-medical applications.

### BACKGROUND

Certain advances in medical technology have increased the number of diagnostic medical equipment present in the operating room. As an example, in some of today's advanced operating rooms in which complex medical procedures are carried out it is not uncommon to find more than a half-dozen high-tech diagnostic instruments, each having its own control console and one or plural monitors. For example, a modern EP lab may include biplane fluoroscopy (4 monitors), multichannel recoding systems (2-3 monitors), one or plural three-dimensional mapping systems (1-2 monitors), intracardiac echocardiography (1 monitor), three-dimensional reconstruction workstations (1-2 monitors) and robotic catheter manipulation systems (2-3 monitors). The numerous types of equipment present in the operating room along with associated cabling can add to operating room clutter, occupy valuable space, and make it difficult for the attending physician or attending team to monitor and control necessary instruments as well as execute surgical tasks.

### SUMMARY

In some aspects, the present disclosure is directed to a method. The method may include receiving, by a first computing device, a wireless signal associated with a second computing device. The method may include determining, by the first computing device, an identifier of the second computing device based at least in part on information in the wireless signal. The method may include determining, by the first computing device, based at least in part on the identifier of the second computing device, a window in a display configuration, the window configured to display data from the second computing device. The method may include receiving, by the first computing device, the data from the second computing device. The method may include displaying, by the first computing device, the data in the window in the display configuration.

In some aspects, receiving the wireless signal may include detecting, by the first computing device, at least one of a radio frequency identification signal, a Wi-Fi signal, a Bluetooth signal, an infrared signal, and an ultrawideband signal from the second computing device. In some aspects, receiving the wireless signal may include receiving, by the first computing device, a wireless signal from a telecommunications network indicating the second computing device is proximate to the first computing device. In some aspects, the wireless signal from the telecommunications network may be a 4G signal. In some aspects, determining the identifier of the second computing device may include determining, by the first computing device, an identification number of the second computing device from the information in the wireless signal.

In some aspects, determining the identifier of the second computing device may include determining, by the first computing device, a type of device based at least in part on the identification number. In some aspects, determining the type of device based at least in part on the identification number may include retrieving, by the first computing device, an entry from a look-up table based at least in part on the identification number, the entry including the type of device corresponding to the identification number. In some aspects, determining the window in the display configuration may include determining, by the first computing device, an inactive window in the display configuration, and selecting, by the first computing device, the inactive window for the second computing device.

In some aspects, determining the window in the display configuration may include determining, by the first computing device, a priority level of the second computing device based at least in part on the identifier of the second computing device; determining, by the first computing device, a window in the display configuration corresponding to the priority level of the second computing device; and selecting, by the first computing device, the window in the display configuration corresponding to the priority level of the second computing device.

In some aspects, determining the priority level of the second computing device based at least in part on the identifier may include retrieving, by the first computing device, an entry from a look-up table based at least in part on the identifier, the entry including the priority level corresponding to the identifier of the second computing device. In some aspects, determining the priority level of the second computing device based at least in part on the identifier may include determining, by the first computing device, a type of device based at least in part on the identifier of the second computing device; and determining, by the first computing device, the priority level based at least in part on the type of device. In some aspects, determining the type of device based at least in part on the identifier of the second computing device may include determining, by the first computing device, that an identifier of the second computing device corresponds to at least one of an x-ray machine, an x-ray image intensifier, an ultrasound machine, a hemodynamic system, and a c-arm.

In some aspects, determining the priority level based at least in part on the type of device may include retrieving, by the first computing device, an entry from a look-up table based at least in part on the type of device, the entry including the priority level of the type of device. In some aspects, determining the window in the display configuration corresponding to the priority level of the second computing device may include comparing, by the first computing device, the priority level of the second computing device with priority levels of a plurality of computing devices associated with windows in the display configuration; and determining, by the first computing device, a ranking of the second computing device among the plurality of computing devices associated with the windows in the display configuration.

In some aspects, selecting the window in the display configuration corresponding to the priority level of the second computing device may include selecting, by the first computing device, the window according to the ranking of the second computing device among the plurality of computing devices associated with the windows in the display configuration. In some aspects, determining the window in the display configuration based at least in part on the identifier of the second computing device may include selecting, by the first computing device, a display configuration with windows to display data received from a plurality of computing devices in communication with the first computing device and the data from the second computing device; determining, by the first computing device, a ranking of the second computing device among the plurality of computing devices in communication with the first computing device; and selecting, by the first computing device, the window in the display configuration according to the ranking of the second computing device among the plurality of computing devices in communication with the first computing device.

In some aspects, receiving the data from the second computing device may include receiving the data via the wireless signal from the second computing device. In some aspects, receiving the data from the second computing device may include receiving the data via a second wireless signal from the second computing device. In some aspects, receiving the data from the second computing device may include sending, by the first computing device, a request for the data in a first data format; and receiving, by the first computing device, the data in the first data format from the second computing device.

In some aspects, the present disclosure is directed to an apparatus. The apparatus may include a processor and a memory. The apparatus may include a first computing device. The memory may store instructions that, when executed by the processor, cause the processor to: receive a wireless signal associated with a second computing device; determine an identifier of the second computing device based at least in part on information in the wireless signal; determine, based at least in part on the identifier of the second computing device, a window in a display configuration, the window configured to display data from the second computing device; receive the data from the second computing device; and/or display the data in the window in the display configuration.

In some aspects, the present disclosure is directed to a non-transitory computer readable medium. The computer readable medium may store instructions that, when executed by a processor, cause the processor to: receive a wireless signal associated with a second computing device; determine an identifier of the second computing device based at least in part on information in the wireless signal; determine, based at least in part on the identifier of the second computing device, a window in a display configuration, the window configured to display data from the second computing device; receive the data from the second computing device; and/or display the data in the window in the display configuration.

In some aspects, the present disclosure is directed to a method. The method may include detecting, by a first computing device, a touch input on an area of a touchscreen. The method may include determining, by the first computing device, an application corresponding to the area of the touchscreen that received the touch input. The method may include determining, by the first computing device, an instruction corresponding to the touch input based at least in part on the application. The method may include applying, by the first computing device, the instruction to the application.

In some aspects, detecting the touch input on the area of the touchscreen may include determining, by the first computing device, a first pair of coordinates on the touchscreen corresponding to a beginning of the touch input; and determining, by the first computing device, a second pair of coordinates on the touchscreen corresponding to an end of the touch input. In some aspects, detecting the touch input on the area of the touchscreen may include determining, by the first computing device, a first pair of coordinates on the touchscreen corresponding to a beginning of a first subpart of the touch input; determining, by the first computing device, a second pair of coordinates on the touchscreen corresponding to an end of the first subpart of the touch input; determining, by the first computing device, a third pair of coordinates on the touchscreen corresponding to a beginning of a second subpart of the touch input; and determining, by the first computing device, a fourth pair of coordinates on the touchscreen corresponding to an end of the second subpart of the touch input.

In some aspects, detecting the touch input on the area of the touchscreen may include determining, by the first computing device, a difference between a temporal metric of a first pair of coordinates on the touchscreen and a temporal metric of a second pair of coordinates on the touchscreen; determining, by the first computing device, that the difference exceeds the timing threshold; after determining that the difference exceeds the timing threshold: associating, by the first computing device, the first pair of coordinates with a first grouping associated with a first subpart of the touch input, and associating, by the first computing device, the second pair of coordinates with a second grouping associated with a second subpart of the touch input.

In some aspects, detecting the touch input on the area of the touchscreen may include determining, by the first computing device, a difference between a location of a first pair of coordinates on the touchscreen and a location of a second pair of coordinates on the touchscreen; determining, by the first computing device, that the difference exceeds a spatial threshold; after determining that the difference exceeds the spatial threshold: associating, by the first computing device, the first pair of coordinates with a first grouping associated with a first subpart of the touch input when the difference exceeds the spatial threshold, and associating, by the first computing device, the second pair of coordinates with a second grouping associated with a second subpart of the touch input when the difference exceeds the spatial threshold.

In some aspects, determining the application corresponding to the area of the touchscreen that received the touch input may include matching, by the first computing device, a first pair of coordinates associated with the touch input with a window on a display configuration; and determining, by the first computing device, the application associated with the window. In some aspects, determining the application corresponding to the area of the touchscreen that received the touch input may include determining, by the first computing device, the application whose data is being displayed at a first pair of coordinates associated with the touch input. In some aspects, determining the instruction corresponding to the touch input based at least in part on the application may include determining, by the first computing device, a type of user gesture based on the touch input. In some aspects, determining the type of user gesture may include determining, by the first computing device, the type of user gesture is at least one of a tap, a double tap, a swipe, a pinch, and a spread.

In some aspects, determining the instruction corresponding to the touch input based at least in part on the application may include retrieving, by the first computing device, an entry from a look-up table based on a type of user gesture corresponding to the touch input and the application, wherein the entry includes the command associated with the user gesture for the application.

In some aspects, the present disclosure is directed to an apparatus. The apparatus may include a processor and a memory. The apparatus may include a first computing device. The memory may store instructions that, when executed by the processor, cause the processor to: detect a touch input on an area of a touchscreen; determine an application corresponding to the area of the touchscreen that received the touch input; determine an instruction corresponding to the touch input based at least in part on the application; and/or apply the instruction to the application.

In some aspects, the present disclosure is directed to a non-transitory computer readable medium. The computer readable medium may store instructions that, when executed by a processor, cause the processor to: detect a touch input on an area of a touchscreen; determine an application corresponding to the area of the touchscreen that received the touch input; determine an instruction corresponding to the touch input based at least in part on the application; and/or apply the instruction to the application.

In some aspects, the present disclosure is directed to a method. The method may include detecting, by a first computing device, a signal from a marking device proximate to a display. The method may include determining, by the first computing device, an instruction associated with the signal from the marking device. The method may include applying, by the first computing device, the instruction to the display.

In some aspects, detecting the signal from the marking device may include detecting, by an optical sensor of the first computing device, an optical signal from the marking device. In some aspects, detecting the signal from the marking device may include detecting, by a magnetic sensor of the first computing device, a magnetic signal from the marking device. In some aspects, detecting the signal from the marking device may include detecting, by the first computing device, a wireless signal including an identification number of the marking device. In some aspects, determining the instruction associated with the signal from the marking device may include determining, by the first computing device, an instruction to mark an area of the display corresponding to sensors detecting the signal from the marking device. In some aspects, determining the instruction associated with the signal from the marking device may include determining, by the first computing device, a color associated with the marking device based at least in part on an identification number of the marking device.

In some aspects, determining the instruction associated with the signal from the marking device may include determining, by the first computing device, a period of time for markings associated with the marking device to be displayed on the display. In some aspects, determining the period of time for markings associated with the marking device to be displayed on the display may include determining the period of time based at least in part on an identification number of the marking device. In some aspects, determining the period of time for markings associated with the marking device to be displayed on the display may include determining to display the markings between about 2 and about 10 seconds. In some aspects, determining the period of time for markings associated with the marking device to be displayed on the display may include determining to display the markings until the first computing device receives an instruction to erase the markings. In some aspects, applying the instruction to the display may include writing, by the first computing device, markings to an area of the frame buffer corresponding to the area of the display corresponding to sensors detecting the signal from the marking device.

In some aspects, the present disclosure is directed to an apparatus. The apparatus may include a processor and a memory. The apparatus may include a first computing device. The memory may store instructions that, when executed by the processor, cause the processor to: detect a signal from a marking device proximate to a display; determine an instruction associated with the signal from the marking device; and/or apply the instruction to the display.

In some aspects, the present disclosure is directed to a non-transitory computer readable medium. The computer readable medium may store instructions that, when executed by a processor, cause the processor to: detect a signal from a marking device proximate to a display; determine an instruction associated with the signal from the marking device; and/or apply the instruction to the display.

In some aspects, the present disclosure is directed to a method. The method may include detecting, by a central processing station, a first wireless signal from a first medical instrument indicating that the first medical instrument is proximate to the central processing station, wherein the first wireless signal comprises at least one of a radio frequency identification signal, a Wi-Fi signal, a Bluetooth signal, an infrared signal, and an ultrawideband signal from a first medical instrument. The method may include determining, by the central processing station, a first identifier associated with the first medical instrument from the first wireless signal. The method may include determining, by the central processing station, a type of device based at least in part on the first identifier.

The method may include determining, by the central processing station, a first window in a first display configuration based at least in part on the type of device, wherein the first window displays first data from the first medical instrument. The method may include receiving, by the central processing station, the first data from the first medical instrument. The method may include displaying, by the central processing station, the first data in the first window in the first display configuration. The method may include detecting, by the central processing station, a second wireless signal from a telecommunications network indicating that a second medical instrument is proximate to the central processing station, wherein the second wireless signal comprises a 4G signal.

The method may include determining, by the central processing station, a second identifier associated with the second medical instrument from the second wireless signal, wherein the second identifier is an identification number. The method may include determining, by the central processing station, a second display configuration, the second display configuration configured to display at least the first data from the first medical instrument and second data from the second medical instrument. The method may include displaying, by the central processing station, the second display configuration. The method may include determining, by the central processing station, a second window in the second display configuration based at least in part on the type of device. The method may include displaying, by the central processing station, the first data from the first medical instrument in the second window. The method may include determining, by the central processing station, a third window in the second display configuration based on the identification number of the second medical instrument. The method may include receiving, by the central processing station, the second data from the second medical instrument. The method may include displaying, by the central processing station, the second data in the third window in the second display configuration.

In some aspects, the present disclosure is directed to an apparatus. The apparatus may include a processor and a memory. The memory may store instructions that, when executed by the processor, cause the processor to: detect a first wireless signal from a first medical instrument indicating that the first medical instrument is proximate to a central processing station, wherein the first wireless signal comprises at least one of a radio frequency identification signal, a Wi-Fi signal, a Bluetooth signal, an infrared signal, and an ultrawideband signal from a first medical instrument, determine a first identifier associated with the first medical instrument from the first wireless signal, determine a type of device based at least in part on the first identifier, determine a first window in a first display configuration based at least in part on the type of device, wherein the first window displays first data from the first medical instrument, receive the first data from the first medical instrument, and/or display the first data in the first window in the first display configuration.

The memory may store instructions that, when executed by the processor, cause the processor to: detect a second wireless signal from a telecommunications network indicating that a second medical instrument is proximate to the central processing station, wherein the second wireless signal comprises a 4G signal, determine a second identifier associated with the second medical instrument from the second wireless signal, wherein the second identifier is an identification number, determine a second display configuration, the second display configuration configured to display at least the first data from the first medical instrument and second data from the second medical instrument, display the second display configuration, determine a second window in the second display configuration based at least in part on the type of device, display the first data from the first medical instrument in the second window, determine a third window in the second display configuration based on the identification number of the second medical instrument, receive the second data from the second medical instrument, and/or display the second data in the third window in the second display configuration.

In some aspects, the present disclosure is directed to a non-transitory computer readable medium. The computer readable medium may store instructions that, when executed by a processor, cause the processor to: detect a first wireless signal from a first medical instrument indicating that the first medical instrument is proximate to a central processing station, wherein the first wireless signal comprises at least one of a radio frequency identification signal, a Wi-Fi signal, a Bluetooth signal, an infrared signal, and an ultrawideband signal from a first medical instrument, determine a first identifier associated with the first medical instrument from the first wireless signal, determine a type of device based at least in part on the first identifier, determine a first window in a first display configuration based at least in part on the type of device, wherein the first window displays first data from the first medical instrument, receive the first data from the first medical instrument, and/or display the first data in the first window in the first display configuration.

The computer readable medium may store instructions that, when executed by a processor, cause the processor to: detect a second wireless signal from a telecommunications network indicating that a second medical instrument is proximate to the central processing station, wherein the second wireless signal comprises a 4G signal, determine a second identifier associated with the second medical instrument from the second wireless signal, wherein the second identifier is an identification number, determine a second display configuration, the second display configuration configured to display at least the first data from the first medical instrument and second data from the second medical instrument, display the second display configuration, determine a second window in the second display configuration based at least in part on the type of device, display the first data from the first medical instrument in the second window, determine a third window in the second display configuration based on the identification number of the second medical instrument, receive the second data from the second medical instrument, and/or display the second data in the third window in the second display configuration.

In some aspects, the present disclosure is directed to a method. The method may include determining, by a central processing station, a first pair of coordinates on a touchscreen and a first time, the first pair of coordinates and the first time associated with a beginning of a touch input. The method may include determining, by the central processing station, a second pair of coordinates on the touchscreen and a second time, the second pair of coordinates and the second time associated with an end of the touch input. The method may include determining, by the central processing station, a type of user gesture associated with the touch input based at least in part on the first pair of coordinates, the first time, the second pair of coordinates, and the second time. The method may include determining, by the central processing station, an application associated with at least the first pair of coordinates and the second pair of coordinates on the touchscreen. The method may include determining, by the central processing station, an instruction based at least in part on the user gesture and the application. The method may include applying, by the central processing station, the instruction to the application.

In some aspects, the present disclosure is directed to an apparatus. The apparatus may include a processor and a memory. The memory may store instructions that, when executed by the processor, cause the processor to: determine a first pair of coordinates on a touchscreen and a first time, the first pair of coordinates and the first time associated with a beginning of a touch input; determine a second pair of coordinates on the touchscreen and a second time, the second pair of coordinates and the second time associated with an end of the touch input; determine a type of user gesture associated with the touch input based at least in part on the first pair of coordinates, the first time, the second pair of coordinates, and the second time; determine an application associated with at least the first pair of coordinates and the second pair of coordinates on the touchscreen; determine an instruction based at least in part on the user gesture and the application; and/or apply the instruction to the application.

In some aspects, the present disclosure is directed to a non-transitory computer readable medium. The computer readable medium may store instructions that, when executed by a processor, cause the processor to: determine a first pair of coordinates on a touchscreen and a first time, the first pair of coordinates and the first time associated with a beginning of a touch input; determine a second pair of coordinates on the touchscreen and a second time, the second pair of coordinates and the second time associated with an end of the touch input; determine a type of user gesture associated with the touch input based at least in part on the first pair of coordinates, the first time, the second pair of coordinates, and the second time; determine an application associated with at least the first pair of coordinates and the second pair of coordinates on the touchscreen; determine an instruction based at least in part on the user gesture and the application; and/or apply the instruction to the application.

In some aspects, the present disclosure is directed to a method. The method may include detecting a first signal from a marking device. The method may include determining, by a central processing station, a first pair of coordinates on a display associated with the signal from the marking device. The method may include determining, by a central processing station in communication with the display, an identifier associated with the marking device. The method may include determining, by the central processing station, a color associated with the identifier. The method may include determining, by the central processing station, an amount of time that an input from the marking device shall be displayed on the display, the amount of time associated with the identifier. The method may include sending, by the central processing station, a second signal to the display to cause the color to be displayed at the first pair of coordinates on the display.

The identifier may include an identification number.

In some aspects, the present disclosure is directed to an apparatus. The apparatus may include a processor and a memory. The memory may store instructions that, when executed by the processor, cause the processor to: detect a first signal from a marking device; determine a first pair of coordinates on a display associated with the signal from the marking device, the display in communication with a central processing station; determine an identifier associated with the marking device; determine a color associated with the identifier; determine an amount of time that an input from the marking device shall be displayed on the display, the amount of time associated with the identifier; and/or send a second signal to the display to cause the color to be displayed at the first pair of coordinates on the display.

In some aspects, the present disclosure is directed to a non-transitory computer readable medium. The computer readable medium may store instructions that, when executed by a processor, cause the processor to: detect a first signal from a marking device; determine a first pair of coordinates on a display associated with the signal from the marking device, the display in communication with a central processing station; determine an identifier associated with the marking device; determine a color associated with the identifier; determine an amount of time that an input from the marking device shall be displayed on the display, the amount of time associated with the identifier; and/or send a second signal to the display to cause the color to be displayed at the first pair of coordinates on the display.

In some aspects, the present disclosure is directed to an apparatus. The apparatus may include a processor and a memory. The memory may store instructions that, when executed by the processor, cause the processor to implement one or more of the methods, or one or more acts of the methods, described herein.

In some aspects, the present disclosure is directed to a non-transitory computer readable medium. The computer readable medium may store instructions that, when executed by a processor, cause the processor to implement one or more of the methods, or one or more acts of the methods, described herein.

The foregoing and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1 is a block diagram representative of an integration system 100 in communication with a plurality of medical instruments 130-138.

FIG. 2 is a flow diagram representing an exemplary method of determining an instruction received on an area of a touchscreen.

FIG. 3 is a block diagram representing an embodiment of the central processing station of the inventive integration system for medical instruments.

FIG. 4 is a block diagram representing an additional embodiment of the central processing station of the inventive integration system for medical instruments.

FIG. 5 is a block diagram representing an additional embodiment of the central processing station of the inventive integration system for medical instruments.

FIG. 6A depicts an embodiment of a computing device 500 which can be included as part of the central processing station 110.

FIG. 6B depicts an embodiment of a computing device 500 which can be included as part of the central processing station 110.

FIG. 6C depicts a computing environment within which the integration system can operate.

FIG. 7 is a flow diagram representing an exemplary method of determining an instruction from a marking device.

FIGS. 8-10 depict exemplary display configurations by which data associated with medical instruments may be displayed.

FIG. 11 is a flow diagram representing an exemplary method of determining the presence of a medical instrument via a wireless signal and displaying data from the medical instrument.

The features and advantages of the present invention will become more apparent from the detailed description set forth below when taken in conjunction with the drawings.

### DETAILED DESCRIPTION

### I. System Overview

An integration system for medical instruments is described in various embodiments. In certain embodiments, the integration system is useful for coordinating control of and managing information provided by a plurality of medical instruments used in complex image-guided surgical procedures. The integration system further provides for high-fidelity communications among surgical team members, and allows for the recording of plural types of data, e.g., digital data, analog data, video data, instrument status, audio data, from a plurality of instruments in use during a surgical procedure. In some embodiments, the integration system minimizes the need for keyboard, mouse or other highly interactive tactile control/interface mechanisms, and can provide an effective, efficient and sterile interface between medical staff members and clinical technology. In certain embodiments, the integration system performs self-diagnostic procedures and automated tasks which aid the attending physician or attending team. The integration system can be used in a wide variety of surgical settings, e.g., electrophysiology laboratories, catheter laboratories, image guided therapy, neurosurgery, radiology, cardiac catheterization, operating room, and the like. In certain embodiments, the integration system is adapted for use in patient rooms, bays or isolettes within emergency medicine, trauma, intensive care, critical care, neo-natal intensive care as well as OB/GYN, labor and delivery facilities. The integration system can also be used in non-surgical settings which utilize image-guided technology, e.g., investment and market monitoring, manufacturing and process plant monitoring, surveillance (e.g., at casinos), navigating a ship/airplane/space shuttle/train, and so on.

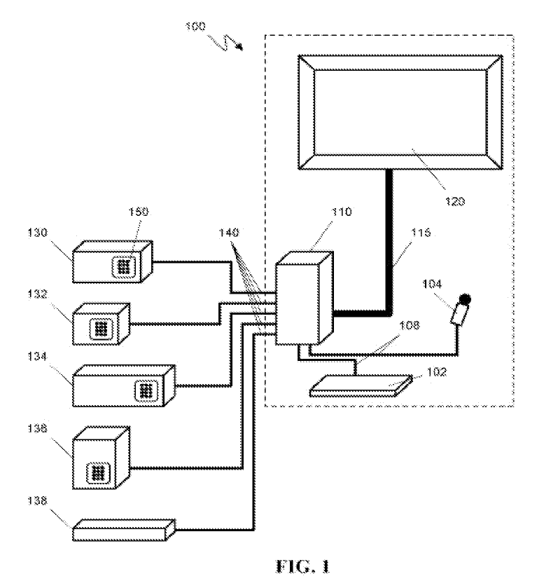

Referring now to FIG. 1, an embodiment of an integration system 100 for medical instruments is depicted in block diagram form. In overview, the inventive integration system comprises a central processing station 110 in communication with one or plural high-resolution, video-display devices 120 via communication link 115. The central processing station 110 can include and be in communication with one or plural control consoles 102, via a first communication link 108. Additionally, the central processing station can include an audio communication subsystem adapted to receive audio input from one or plural external audio devices 104 via a second communication link 108. The central processing station can further receive, and transmit, plural types of data over communication links 140 from, and to, a plurality of medical instruments 130, 132, 134, 136, 138. One or more of the plurality of medical instruments may have native controls 150, normally used to operate the instrument. The central processing station 110 can also receive audio data from the audio communication subsystem.

In various embodiments, any components of the inventive integration system 100 placed in an operating room can undergo sterilization treatment. In some embodiments, the main high-resolution video display 120 and control console 102 is coated with an FDA certified anti-bacterial powder. In some embodiments, the main high-resolution video display 120 is covered with a clear sterilized mylar film or similar material. The use of a film can allow a team member to draw visual aids on the display, e.g., an intended destination for a catheter, without permanently marking the monitor. An additional advantage of using a film is its easy disposal after a procedure.

In various embodiments, communication link 115 is a fiber optic link or an optical link, and data transmitted over link 115 is substantially unaffected by magnetic fields having a field strengths between about 0.5 Tesla (T) and about 7 T, between about 1 T and about 7 T, between about 2 T and about 7 T, and yet between about 4 T and about 7 T. In certain embodiments, high magnetic fields substantially do not affect timing sequences of data transmitted over link 115. In some embodiments, communication link 115 comprises an ultrasonic, infrared, or radio-frequency (RF) communication link. In some embodiments, the communication links 140, 108 are wired, whereas in some embodiments, the communication links are wireless, e.g., infrared, ultrasonic, optical, or radio-frequency communication links. In some embodiments, the communication links 140, 108 are fiber optic or optical links. Transmission of data which is substantially unaffected by high magnetic fields is advantageous when the integration system is used in a facility having a nuclear magnetic resonance (NMR) imaging apparatus or any apparatus producing high magnetic fields. In certain embodiments, the optical link comprises a DVI cable, e.g., a DVI-D fiber optic cable available from DVI Gear, Inc. of Marietta, Ga.

### II. System Operation and Control

As an overview of system operation, the central processing station 110 coordinates operation of the inventive integration system 100. Operation of the integration system 100 comprises control of data and images displayed on the video display 120, control of one or more of the plurality of instruments 130, 132, 134, 136, 138 in communication with the integration system, control of software in operation on the integration system, and control of the recordation of any data handled by the integration system. Software and/or firmware can execute on a central processing unit within the central processing station to assist in overall system operation. The integration system 100 can be controlled by a user operating a control console 102 and/or by voice commands input through an audio device 104. In various aspects, the system 100 has voice-recognition software which recognizes voice input and translates voice commands to machine commands recognizable by an instrument or the central processing station 110. In various aspects, the integration system is adapted to provide coordinated control of the plurality of instruments through at least one control console of the integration system.

The term “control console” is a general term which encompasses any apparatus providing control or command data to the integration system. A control console 102 can comprise a keyboard, a mouse controller, a touchpad controller, manual knobs, manual switches, remote-control apparatus, imaging apparatus adapted to provide control data, audio apparatus, infrared sources and sensors, or any combination thereof. In some embodiments, the control console 102 and software in operation on the integration system provide for “electronic chalkboard” operation, as described below. In some embodiments, a control console 102 comprises a graphical user interface (GUI), which is displayed on all or a portion of the video display 120 or on an auxiliary display 205. In certain embodiments, the GUI is displayed temporarily during operation of the integration system to provide for the inputting of commands to control the integration system.

In various aspects, a user can select one or plural data streams received from the plurality of medical instruments 130, 132, 134, 136, 138 for display on a high-resolution, video-display device 120. The selection of the one or plural data streams can be done in real time by entering commands at a control console 102, or according to preset display configurations. Additionally, in various aspects, a user can operate one or more of the plurality of medical instruments 130, 132, 134, 136, 138 via a control console 102. In various embodiments, the integration system 100 provides for the recording of video data, instrument data, and audio data handled by the system during a procedure.

The effective integration of clinical, video and audio information requires that a physician or other operator have the ability to manipulate such data as to specifically control and prioritize which image or images are viewed, with immediate and customizable control over image selection, layout, location and size and timing. In various embodiments, the central processing station 110 displays simultaneously on the high-resolution video display 120 images representative of a selected group of the plural types of data received from the plurality of instruments 130, 132, 134, 136, 138. The displayed images can be manipulated or altered by a clinician or system operator providing commands through the integration system's control console.

In various embodiments, the inventive integration system 100 is adapted to provide “voice-recognition” control technology. A physician or system operator can, in a sterile environment, control operational aspects of the integration system, e.g., video imaging parameters, displayed data, instrument settings, recorded data, using selected voice commands. In certain embodiments, the integration system's audio communication subsystem is integrated with voice recognition control software to provide for voice-recognition control. Voice-recognition control technology can provide a voice-controlled, no-touch, control console 102, an aspect advantageous for sterile environments. In certain embodiments, the integration system 100 is operated by a user providing voice commands. As an example, preset display configurations for the main video display 120 can be called up by issuance of particular voice commands, e.g., “Carrot one,” “Carrot two,” Carrot three,” etc. The voice commands can be recognized by voice-recognition software in operation on the integration system, and certain voice commands can activate commands which are executed by the integration system or provided to instruments in communication with the system.

In certain embodiments, the integration system 100 is adapted for physician or operator control via “gesture-based” control technology. Such control technology can allow a physician, in a sterile environment, to control and customize substantially immediately various operational aspects of the integration system 100. Gesture-based control technology can be implemented with imaging apparatus, e.g., a camera capturing multi-dimensional motion, infrared or visible light sources and sensors and/or detectors detecting multidimensional motion of an object, and/or with a hand-held control device, e.g., a hand-operated device with motion sensors similar to the Wii controller. Any combination of these apparatuses can be interfaced and/or integrated with the integration system 100. In certain embodiments, the control console 102 is adapted to provide for gesture-based control of the integration system 100. Gesture-based control will give the clinician working within a sterile field, the ability to control the operation of the video integration device without touching a control panel, therefore limiting the risk of breaching a sterile barrier. In certain aspects, gesture-based control technology provides a “no-touch” control console 102.

As one example of gesture-based control, gesture-based control apparatus, e.g., a camera or imaging device, can be adapted to detect and “read” or recognize a clinician's specific hand-movements, and/or finger-pointing and/or gesturing to control which images are displayed, located and appropriately sized on a video display device 120. As another example, a clinician or system operator can hold or operate a remote motion-capture device which provides control data representative of gestures. The motion-capture device can be hand-held or attached to the operator. As another example, a clinician or system operator can don one or a pair of gloves which have a specific pattern, material, a light-emitting device, or a design embossed, printed, disposed on, or dyed into the glove. The glove can have any of the following characteristics: sterile, a surgical glove, latex or non-latex, and provided in all sizes. An imaging system and/or sensors can detect the specific pattern, light-emitting device or design and provide data representative of gestures to the integration system 100. In some embodiments, a wristband, worn by a clinician, is adapted to sense motion or provide a specific pattern or incorporate a light-emitting device. Motion of the wristband can provide data for gesture-based control of the system 100. In some embodiments, gesture-based control is based on facial expressions or gestures, e.g., winking, yawning, mouth and/or jaw movement, etc. Imaging apparatus and image processors can be disposed to detect and identify certain facial gestures.

In certain embodiments, a disposable sterile pouch is provided to encase a gesture-based control device, such as a hand-held motion-capture device. The pouch can prevent bacterial contamination from the device during medical procedures.

In certain embodiments, gestures provide for control of the system 100. The data representative of gestures can be processed by the central processing station 110 to identify commands associated with specific gestures. The central processing station 110 can then execute the commands or pass commands to a medical instrument in communication with the system. As an example, system commands can be associated with specific motion gestures. A gesture-based control apparatus can be moved in a particular gesture to produce data representative of the gesture. The central processing station 110 can receive and process the data to identify a command associated with the gesture and execute the command on the system 100. The association of a command with a gesture can be done by a system programmer, or by a user of the system.

In some embodiments, gesture-based control apparatus is used to operate a graphical user interface (GUI) on the integration system. As an example, a gesture-based control apparatus can be used to move a cursor or pointer on a GUI display, e.g., the pointer can move in substantial synchronicity with the gesture apparatus. Motion in a two-dimensional plane can position a cursor or pointer on a GUI display, and out-of-plane motion can select or activate a GUI button. The GUI can be displayed on the video-display device 120.

In some embodiments, a remote-control device includes pushbuttons or other tactile data input devices, which can be operated by a user to provide command or control data to the integration system. In certain embodiments, a remote control device includes both tactile data input devices as well as motion-capture devices which can provide data representative of gestures to the integration system.

It will be appreciated that the centralization of the control of and display of data from the plurality of medical instruments 130, 132, 134, 136, 138 by the inventive integration system 100 can free the attending surgeon and team members from certain equipment-operation and distributed data-viewing tasks, and improve focus and collaboration necessary for surgical tasks in the operating room. The integration system 100 can also free up valuable space within the operating room, and reduce clutter. Space occupied by a plurality of medical instruments which must be positioned within viewing range of the physician can be recovered, since the instruments may be moved to a remote location and a single control console and video display located near the physician. Additional details, aspects, advantages and features of the inventive integration system 100 are described below.

In some implementations, the control console 102 may include a graphical user interface (GUI), which is displayed on all or a portion of the video display 120 or on an auxiliary display 205. The GUI may be displayed during operation of the integration system to provide for the inputting of commands to control the integration system. In some implementations, the video display and/or auxiliary display 205 may include a touch sensitive screen (e.g., a touchscreen), and a user may input commands to control the integration system according to inputs to the touch sensitive screen.

The touch sensitive screen of the video display 120 may be any type of touch sensitive device. In some implementations, the touch sensitive screen may be a resistive touchscreen. In some implementations, the touch sensitive screen may be a surface acoustic wave touchscreen. In some implementations, the touch sensitive screen may be a capacitive touchscreen, such as surface capacitance touchscreen, a projected capacitance touchscreen, a mutual capacitance touchscreen, or a self-capacitance touchscreen. In some implementations, the touch sensitive screen may be an infrared touchscreen. In some implementations, the touch sensitive screen may be an optical imaging touchscreen. In some implementations, the touch sensitive screen may operate according to dispersive signal technology or acoustic pulse recognition.

In some implementations, the touch sensitive screen may include a two-dimensional array of touch-sensitive components. The central processing station 110 may map each touch-sensitive component of the screen to one or more corresponding pixels on the frame buffer used by the video processing engine 250 to drive displays of data (e.g., data from medical instruments) to the display 120. In some implementations, when a touch-sensitive component of the screen receives a force that exceeds a threshold (e.g., the force is sufficient to indicate that a user has intentionally touched the screen), the component may send a signal to the central processing station 110 indicating that the component has been touched. The central processing station 110 may receive signals from the touch-sensitive components. The station 110 may process the signals to interpret the input touches as a user gesture and/or user command, by way of example.

The central processing station 110 may detect at least one touch input on an area of a touchscreen. The touch input may include a plurality of pairs of coordinates. In some implementations, each pair of coordinates may correspond to a touch-sensitive component that has been activated. In some implementations, each pair of coordinates may correspond to a pixel on the frame buffer that corresponds to the area on the touchscreen activated by the user. In some implementations, each pair of coordinates may include a temporal metric, such as the time when the corresponding touch-sensitive component had been activated. In some implementations, a pair of coordinates may include more than one temporal metric, indicating that the corresponding touch-sensitive component had been activated more than one time.

In some implementations, the central processing station 110 may identify one or more groupings for the activated components within the touch input. The station 110 may process the touch input according to the number of identified groupings. Each grouping may have spatial parameters, temporal parameters, or both.

In some examples, the station 110 may identify a single grouping for the touch input. The station 110 may compare the coordinates of activated components to determine that successive coordinates are substantially adjacent to one another. The station 110 may determine the duration of the touch input by comparing the temporal metric of the latest activated component with the temporal metric of the earliest temporal metric. If the coordinates of activated components are substantially adjacent and the duration of the touch input does not exceed a threshold (e.g., 0.25 seconds, although any duration may be used for the threshold), the station 110 may organize the coordinates of all activated components into the same grouping. Based on the grouping, the station 110 may determine that the activated components correspond to a single motion upon the surface of the video display 120.

In some implementations, the station 110 may detect a beginning of the touch input based on the coordinates. For example, the station 110 may order the pairs of coordinates according to their temporal metrics. In some implementations, the station 110 may select the pair of coordinates with the earliest temporal metric as the beginning of the touch input.

In some implementations, the station 110 may assume that a substantially arched end of the touch input corresponds to a shape of a user's finger, and base the determination of the beginning of the touch input on this assumption. For example, the station 110 may order the pairs of coordinates according to their temporal metrics. The station 110 may apply a shape matching algorithm to coordinates with the earliest temporal metrics to approximate the coordinates of the activated component corresponding to the center of the user's finger.

For example, the station 110 may match an arc of a circle or ellipse to coordinates with the earliest temporal metrics. The station 110 may determine a radius corresponding to the arc of the circle or the focal lengths corresponding to the arc of the ellipse. Using the radius and/or focal lengths, the station 110 may approximate a center of a circle or ellipse corresponding to the arc of the circle or ellipse. The approximated center may be assigned the beginning of the touch input.

In some implementations, the station may detect an end of the touch input based on the coordinates. For example, when coordinates have been ordered according to their temporal metrics, the station 110 may select the pair of coordinates with the latest temporal metric as the end of the touch input. In some examples, the station 110 may apply a shape matching algorithm to the coordinates with the latest temporal metrics to determine the end of the touch input. The station 110 may match an arc of a circle or ellipse to the coordinates and determine a center of a circle or ellipse, as described herein.

In some implementations, the station 110 may compare the distance between the beginning and end of the touch input with a threshold as one way of interpreting the touch input as a user gesture. In some examples, if the distance exceeds the equivalent of 0.5 inches on the video-display 120, the station 110 may interpret the touch input as a “swipe.” In some examples, if the distance exceeds the equivalent of 66 pixels on a display with resolution of 132 pixels per inch (ppi), the station 110 may interpret the touch input as a swipe. In some examples, if the distance exceeds the equivalent of 132 pixels on a display with resolution of 264 pixels per inch (ppi), the station 110 may interpret the touch input as a swipe. In some examples, if the threshold exceeds the distance between the beginning and end of the touch input, the station 110 may interpret the touch input as a “tap.” In some examples, if the distance is less than the equivalent of 66 pixels on a display with resolution of 132 pixels per inch (ppi), the station 110 may interpret the touch input as a tap. Although the threshold in these examples is the equivalent of 0.5 inches on the video-display 120, any other distance for the threshold may be used.

In some implementations, the station 110 may identify multiple groupings for the touch input. The station 110 may identify multiple groupings based on the temporal metrics. For example, the station 110 may determine that a plurality of pairs of coordinates have more than one temporal metric. The central processing station 110 may determine the difference between each successive temporal metric for each pair of coordinates. The station 110 may compare the difference between temporal metrics for a pair of coordinates with a timing threshold. If the difference does not exceed the timing threshold, the station 110 may discard one of the temporal metrics for the pair of coordinates. In this manner, the central processing station 110 may determine that one or more touch components may have been activated superfluously (e.g., by mistake, not meant to form an additional user gesture).

In some implementations, the station 110 may determine the number of pairs of coordinates whose difference in temporal metrics exceeds the timing threshold. The station 110 may compare this number of pairs with a temporal subpart groupings threshold (e.g., the station 110 may determine that sufficient touch sensitive components have been activated more than once to identify an additional subpart of the touch input). In some implementations, the temporal subpart groupings threshold may be a percentage of all the touch sensitive components that have been activated (e.g., 50%, 75%, 85%). In some implementations, the temporal subpart groupings threshold may be a percentage of all the touch sensitive components that have been activated more than once.

If the number of pairs does exceed the temporal subpart groupings threshold, the central processing station 110 may create another grouping (e.g., the station 110 may determine that the touch input includes multiple, separate sub-inputs). In some implementations, the station 110 may create additional groupings when pairs of coordinates include additional temporal metrics such that the difference between temporal metrics exceeds the subpart groupings threshold, according to the methods described herein.

In some implementations, the station 110 may compare the temporal metrics of pairs of coordinates to determine if the corresponding activated components shall be placed in the same grouping. For example, the station 110 may analyze the distribution of temporal metrics (e.g., activation times) associated with the touch sensitive components. The station 110 may organize the groupings according to clusters of pairs of coordinates within the distribution. In some implementations, the station 110 may select a grouping for a pair of coordinates based on the proximity between the pair's temporal metric and the temporal metrics of a cluster within the distribution of times. As the central processing station 110 assigns pairs of coordinates to groupings according to their temporal metrics, the station 110 may effectively separate subparts of the touch input that differ in time.

In some implementations, the station 110 may analyze coordinates in a grouping for substantial spatial continuity. For example, the station 110 may compare the coordinates of activated components to determine which coordinates are substantially adjacent to one another. In some implementations, the station 110 may order coordinates according to their temporal metrics. The station 110 may determine the distance between the first pair of coordinates and the second pair of coordinates. If the distance is smaller than a spatial subpart groupings threshold, the first and second pairs of coordinates may be assigned to the same grouping. The spatial subpart groupings threshold may be any number of pixels, touch sensitive components, or any other metric corresponding to a distance on the video display 120 that indicates the activated components correspond to different subparts of the touch input. In some implementations, the first pair of coordinates may be set as the reference coordinates for the grouping.

In some implementations, if the distance is larger than the spatial subpart groupings threshold, the station 110 may create a new grouping. The station 110 may assign the first pair of coordinates to the first grouping and the second pair of coordinates to the second grouping. The station 110 may set the first and second pairs of coordinates as the references coordinates for their respective groupings. The station 110 may determine the distances between the third pair of coordinates and the first and second pair of coordinates. If one of the distances is smaller than the spatial subpart groupings threshold, the third pair of coordinates may be assigned to the grouping associated with the closest pair of coordinates. If neither distance is smaller than the spatial subpart groupings threshold, the station 110 may create a new grouping, assign the third pair of coordinates to the new grouping, and set the third pair as the reference coordinates for the new grouping. The station 110 may successively compare distances with the pairs of coordinates with the reference coordinates for the groupings to assign each pair of coordinate to a grouping or create a new grouping. In some implementations, the station 110 may set a different pair of coordinates for the reference coordinates in the grouping as the station 110 makes further comparisons for the distances.

For each grouping, the central processing station 110 may determine the beginning and end of the subpart of the touch input, according to any of the methods described herein. The station 110 may interpret the touch input as a user gesture by analyzing the beginning and end of each subpart. In some examples, a touch input may include two groupings of coordinates. The second grouping may have been created when the station 110 identified two clusters within the distribution of temporal metrics of the pairs of coordinates. The distance between the beginning and end for each grouping may be smaller than a spatial subpart groupings threshold. In some implementations, the touch input may be interpreted as a double tap.

In some examples, the touch input may include two groupings of coordinates. The second grouping may have been created when the station 110 was comparing distances between pairs of coordinates ordered according to their temporal metrics (e.g., all the touch sensitive components had been activated at substantially similar times). The central processing station 110 may determine the differences between the vertical and horizontal coordinates of the beginning and end of each subpart. In some implementations, the station 110 may determine a vector of movement for each subpart based on the differences. If the vectors of movement converge, the station 110 may interpret the touch input as a “pinch.” If the vectors of movement diverge, the station 110 may interpret the touch input as a “spread.”

The central processing station 110 may determine an application to which a user command corresponding to the touch input may be applied. For example, the central processing station 110 may match the coordinates for the beginning and end of each subpart of the touch input to coordinates on the video display 120. In some implementations, the station 110 may match the coordinates to coordinates on the frame buffer storing data that the video processing engine 250 drives to the display 120.

The station 110 may determine the application corresponding to the coordinates on the video display 120 and/or frame buffer for each pair of coordinates corresponding to the beginning of a subpart of the touch input. The station 110 may determine the application corresponding to the coordinates on the video display 120 and/or frame buffer for each pair of coordinates corresponding to the end of a subpart of the touch input. In some implementations, the station 110 may determine that the beginnings and ends of all subparts of the touch input correspond to the same application. In some implementations, the station 110 may match coordinates to a window on a display configuration. The station 110 may determine the application associated with the window.

In some implementations, the central processing station 110 may access a table, database, or other data structure to interpret the user gesture as a command. For example, the station 110 may include a table with five entries, “tap,” “double tap,” “swipe,” “pinch,” and “spread.” If the user gesture is a “tap,” the station 110 may interpret the user gesture as a selection of an item. In some implementations, the station 110 may determine an area of the user interface for the application corresponding to the coordinates of the touch input. If the area includes an item for selection, the station 110 may process a selection of the item for the application.

If the user gesture is a “double tap” or a “spread,” the station 110 may interpret the user gesture as a command to zoom in on data on the display. In some implementations, a “double tap” may correspond to a predefined factor of magnification (e.g., 10%, 25%, 33%). In some implementations, the central processing station 110 may determine the factor of magnification based on the magnitude of the vectors of movement corresponding to the touch input. For example, the central processing station 110 may determine the lengths of the vector for the two groupings of the “spread.” The station 110 may multiply the averaged length of the vectors by a coefficient to determine the magnification factor (e.g., the magnification factor may be proportional to the averaged length of the vectors). In some implementations, for each 0.25 inches of the average length, the magnification factor may increase by 10%. Thus, the magnification factor for a touch input whose average length for the vectors of movement is 0.75 inches long may be 1.10*1.10*1.10=1.331, or 33.1%. The central processing station 110 may perform interpolation, or any other algorithm, on data for the application to display a zoomed-in view of data for the application.

If the user gesture is a “pinch,” the station 110 may interpret the user gesture as a command to zoom out of data on the display. In some implementations, the central processing station 110 may determine the factor of compression based on the magnitude of the vectors of movement corresponding to the touch input. For example, the central processing station 110 may determine the lengths of the vectors and derive the compression factor from their average length, similar to the methods described herein for determining the magnification factor. The central processing station 110 may perform sampling, or any other algorithm, on data for the application to display a zoomed-out view of data for the application.

If the user gesture is a “swipe,” the station 110 may interpret the user gesture as a command to pan to another part of data being displayed. For example, the station 110 may display a subset of the data received from a medical instrument 130. The station 110 may store four pairs of coordinates corresponding to boundaries framing the subset of data from the medical instrument being displayed on the video display 120. In some implementations, the station 110 may determine a vector of movement corresponding to the user gesture. The central processing station 110 may determine a magnitude for panning based on the length of the vector of movement. The station 110 may update the four pairs of coordinates based on the vector.

In some implementations, the station 110 may interpret the user gesture as a command for a medical instrument to pan a camera associated with the instrument so the camera captures data from a different location. In some implementations, the station 110 may determine a vector of movement corresponding to the user gesture. The vector may be based on the horizontal displacement between the beginning and end of the touch input, the vertical displacement between the beginning and end, or both. In some implementations, the central processing station 110 may determine a magnitude for panning based on the length of the vector of movement. The station 110 may determine an instruction for panning for the medical instrument 130. The station 110 may transmit the instruction to the medical instrument 130, and the instrument 130 may pan its camera in response.

In some implementations, the station 110 may interpret the user gesture as a command based at least in part on the application to which the gesture is applied. The station 110 may determine the application according to the coordinates on the video display 120 and/or frame buffer for each pair of coordinates corresponding to the beginning of a subpart of the touch input, as described herein. In some implementations, the station 110 may determine the application according to the application present at the majority of the beginnings and ends of the subparts of the touch input. In some implementations, the station 110 may determine the application according to the application present at a threshold number of the beginnings and ends of the subparts of the touch input.

The station 110 may access an entry in a table, database, or any other structure to determine the command to apply to the application, based on the user gesture. In some implementations, when the application is an audio player, a user gesture of a single tap may be interpreted as a command to play audio data associated with the player. In some implementations, when the application is an image viewer, a user gesture of a single tap may be interpreted as a command to edit the data on display by the image viewer. The station 110 may make a copy of the image data on display and display editing tools for the user. In some implementations, when the application is a video projector for data received from a medical instrument 130, a user gesture of a single tap may be interpreted as a command to capture data received from the instrument 130 as a video file.

In some implementations, when the application is an audio player, a user gesture of a horizontal swipe may be interpreted as a command to delete the audio file being played by the audio player. In some implementations, when the application is an image viewer, a user gesture of a horizontal swipe may be interpreted as a command to move data on display by the image viewer to a different location. For example, the station 110 may write the data on display to an area on the frame buffer centered by the coordinates of the end of the touch input. In some implementations, when the application is a video player, a user gesture of a horizontal swipe may be interpreted as a command to advance the video file being played by the video player by a predetermined amount of time.

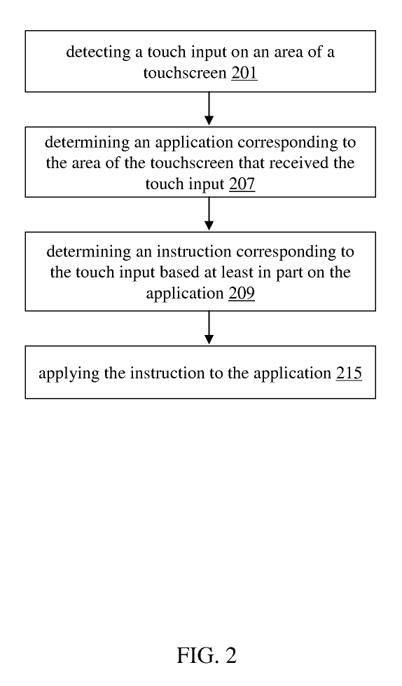

Referring now to FIG. 2, a flow diagram of an exemplary method is shown and described. The method may include detecting a touch input on an area of a touchscreen (step 201). The method may include determining an application corresponding to the area of the touchscreen that received the touch input (step 207). The method may include determining an instruction corresponding to the touch input based at least in part on the application (step 209). The method may include applying the instruction to the application (step 215).

### III. Central Processing Station and Computing Environment

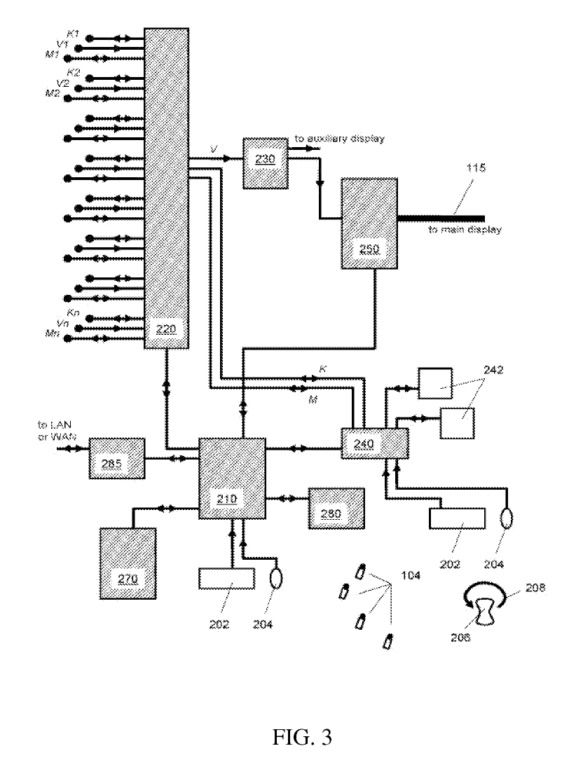

Various embodiments of a central processing station 110 are depicted in the block diagrams of FIGS. 3-5. The shaded blocks indicate elements comprising the central processing station, and unshaded blocks indicate peripheral components which can be in communication with the central processing station. In some embodiments, the peripheral components can be included with the central processing station.

The central processing station 110 can comprise a computing device or computing machine, e.g., a computer system, a personal computer, a laptop computer, one or plural central processors, one or plural microcontrollers, or one or plural microprocessors. In some embodiments, the central processing station comprises a central processing unit 210 executing computer code. The central processing station 110 can further comprise various electronic hardware in communication with the central processing station 110, e.g., one or plural data acquisition boards (not shown), one or plural audio communication boards or electronics 280 (e.g., a DX200 audio system available from HME of Poway, Calif.; a G280 mixed amplifier available from Crown International of Elkhart, Ind.), one or plural video graphics boards (not shown), one or plural internet modems 285, one or plural wireless communication modems 290, one or plural keyboard-video-mouse (KVM) switches 220, one or plural video amplifier splitters 230, one or plural digital signal processors (not shown), one or plural digital-to-analog converters (not shown), one or plural analog-to-digital converters (not shown), one or plural memory devices 270, a peripheral controller 240, or any combination of the foregoing elements. In certain embodiments, video and instrument data can be handled by a video/data wall processor, e.g., MediaWall 2500 available from RGB Spectrum of Alameda, Calif.; and digital repeater, e.g., DVI-5314b available from DVI Gear of Marietta, Ga.

In some embodiments, one or plural touchpads 242 are in communication with a peripheral controller 240, and one or plural communication devices 104 can be in communication with an audio communication board 280. In some embodiments, one or plural keyboards 202, one or plural mouse controllers 204, one or plural remote-control devices 206, and/or one or plural auxiliary monitors 205 are in communication with the central processing station 110. In some embodiments, one or plural video monitors 205 are in communication with a KVM switch 220, or video processing engine 250. In various embodiments, the central processing station 110 is in communication with a video processing engine 250, which provides data and video images for a main high-resolution display 120.

A remote-control device 206 can comprise a gesture-based control apparatus. In some embodiments, a remote-control device 206 comprises a motion-sensing device that is operated by a system user, e.g., moved in specific patterns 208 which correspond to commands recognized by the system. In some embodiments, a remote-control device 206 comprises a glove, wristband or other apparel with a specific pattern which can be imaged or sensed by a camera or imaging device. In some embodiments, a remote-control device 206 comprises a glove, wristband or other apparel with a light-emitting device, e.g., a laser, LED, organic light-emitting diode, for which the emitted light can be detected by one or plural optical sensors. In some embodiments, a remote-control device 206 comprises a handheld device with either or both a specific pattern and light-emitting device. In some embodiments, the remote-control device 206 comprises a handheld device adapted for gesture-based operation and including tactile data input controls, e.g., pushbuttons, keypads, etc.

The phrase “command recognized by the system” pertains to control or command data produced by an input device, e.g., audio device 104, mouse controller 204, keyboard 202, remote-control device 206, and the like, which can be processed by the central processing station and identified as a command to affect operation of the system. In some embodiments, the control or command data is associated with a predefined section of executable computer code. Upon receiving a particular control or command data, the central processing station executes the section of code associated with the particular command. The association of a particular command with a particular section of executable code can be established during development of the integration system or by a system user, e.g., a user identifying particular sections of executable codes to be associated with particular voice commands or gestures.

In some embodiments as depicted in FIG. 3, data from a plurality of medical instruments are received by a KVM switch 220. The data received can include digital data or analog data derived from various physiological sensors and can include video data derived from various medical imaging instruments. The KVM switch 220 can include bi-directional data lines, e.g., bi-directional data lines for keyboard data K1, K2, . . . Kn, and bi-directional data lines for mouse controller data M1, M2, . . . Mn. The KVM switch 220 can further include video input lines V1, V2, . . . Vn. Each keyboard-video-mouse data set, e.g., K1, V1, M1, can be associated with a single medical instrument, e.g., a robotic catheter manipulation system. The KVM switch 220 can be in communication with the central processing unit 210, and commands from a control console 102, handled by the central processor and passed to the KVM switch 220, can select one or plural keyboard-video-mouse data sets for activation and/or display on the main display 120. In various embodiments, commands from a control console 102 are passed back to one of the medical instruments 130, 132, 134, 136, 138. When a particular data set is activated, e.g., a data set corresponding to one medical instrument 134, then the instrument becomes controllable by a user entering commands from a control console 102, or inputting voice commands through an audio device 104, or inputting commands through a touchpad 242, or via remote-control device 206. In certain embodiments, voice-recognition software executes on the central processing unit 210 and translate voice commands received through the audio communication board 280 into recognizable system commands or instrument commands, e.g., commands to alter the display configuration of the video display 120 or to alter a setting on one of the medical instruments 130, 132, 134, 136, 138. In various embodiments, system commands affect operation of the inventive integration system 100, and instrument commands affect operation of one or plural peripheral medical instruments 130, 132, 134, 136, 138. In various embodiments, the control of different medical instruments in communication with the integration system 100 is seamlessly switchable from one instrument to the next from a single control console 102.

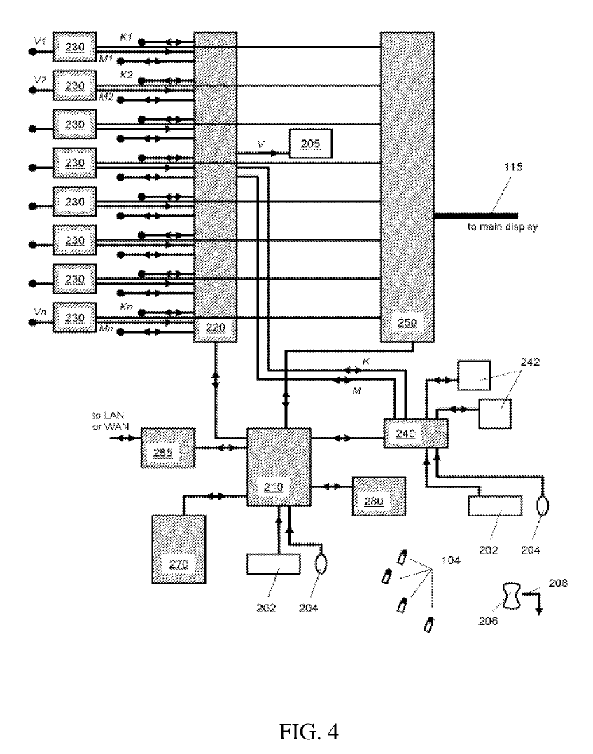

In various embodiments, selected data, designated K, V, M in FIGS. 3-4 is output from the KVM switch 220. In some embodiments, video data V is sent to a video amplifier splitter 230 where the video signal can be split and amplified. Outputs from the video amplifier splitter 230 can be displayed on an auxiliary monitor or display 205, e.g., a backup display, or a second display located in a control room, and can be fed into a video processing engine 250.

In various embodiments, keyboard K and mouse M data is fed to peripheral controller 240. In some embodiments, the keyboard K and mouse M data is fed directly to a keyboard 202 and mouse controller 204. In yet other embodiments, the keyboard K and mouse M data is fed to the central processing unit 210.

The peripheral controller 240 can be in communication with the central processing unit 210, one or plural touchpad controllers 242, a keyboard 202, a mouse controller 204, and remote-control device 206. The peripheral controller 240 can receive command inputs from the one or plural touchpads 242, a keyboard 202, a mouse controller 204, remote-control device 206, the central processing unit 210, or any combination thereof and relay commands back to a medical instrument through the KVM switch. In some embodiments, commands received by the peripheral controller are passed through and optionally processed by the central processing unit 210 and transmitted to one or plural medical instruments.

In some embodiments, a touchpad 242, keyboard 202, mouse controller 204, remote-control device 206, and auxiliary monitor or display 205 are located in a control room. The control room can be remote from the operating room, or a partitioned room adjacent the operating room. In certain embodiments, partial or full control of the inventive integration system 100 is executed from the touchpad 242, keyboard 202, mouse controller 204, or remote-control device 206, located in the control room. In some embodiments, the integration system 100 provides a cursor on the main high-resolution video display 120 which can be moved and altered using the touchpad 242, keyboard 202, and/or mouse controller 204 located in the control room. This can allow a control-room participant to draw the attention of an operating-room participant to particular data displayed on the main high-resolution video display 120.

In various embodiments, the video processing engine 250 prepares data for display on the high-resolution video display device 120. The high-resolution video display 120 can comprise a 56-inch, 8 megapixel flat-panel monitor, e.g., an LCD flat panel display model P56QHD available from Toshiba of Simi Valley, Calif. In various aspects, the high-resolution display provides for improved accurate and detailed identification of certain physiological features. The video processing engine 250 can accept video data in one or plural data formats and output video data in a format suitable for display on a high-resolution video-display 120.

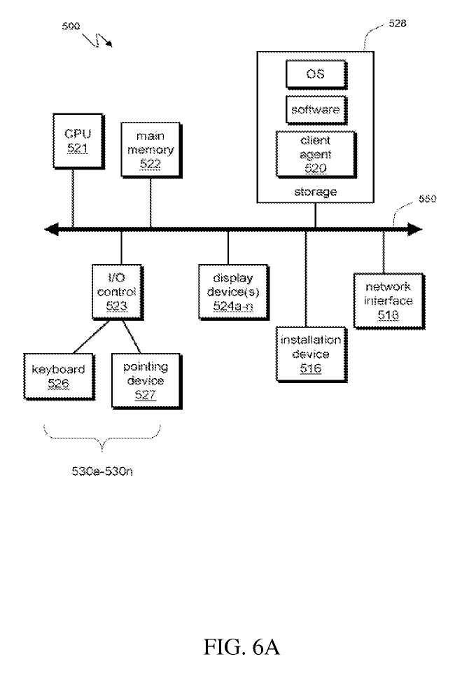

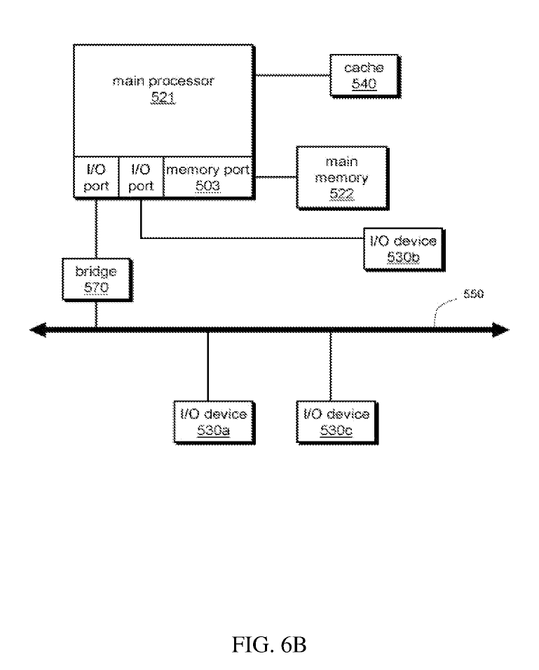

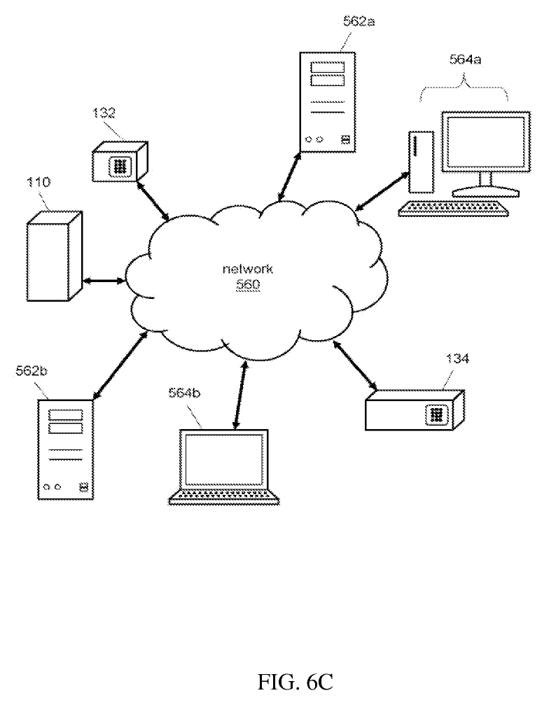

Further details about the central processing station 110 and its computing environment will now be provided. In certain embodiments, the central processing station 110 comprises a computing device or machine 500 as depicted in FIG. 6A. Included within the computing device 500 is a system bus 550 that communicates with the following components: a central processing unit 521; a main memory 522; storage memory 528; an input/output (I/O) controller 523; display devices 524a-524n; an installation device 516; and a network interface 518. In one embodiment, the storage memory 528 includes: an operating system, software routines, and a client agent 520. The I/O controller 523, in some embodiments, is further connected to a key board 526, and a pointing device 527. Other embodiments may include an I/O controller 523 connected to more than one input/output device 530a-530n.

FIG. 6B illustrates an additional embodiment of a computing device 500. Included within the computing device 500 is a system bus 550 that communicates with the following components: a bridge 570, and a first I/O device 530a. In some embodiments, the bridge 570 is in further communication with the central processing unit 521, where the central processing unit 521 can further communicate with a second I/O device 530b, a main memory 522, and a cache memory 540. Included within the central processing unit 521, are I/O ports, a memory port 503, and a main processor.

Embodiments of the computing machine 500 can include a central processing unit 521 characterized by any one of the following component configurations: logic circuits that respond to and process instructions fetched from the main memory unit 522; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits capable of executing the systems and methods described herein. Still other embodiments of the central processing unit 521 may include any combination of the following: a microprocessor, a microcontroller, a central processing unit with a single processing core, a central processing unit with two processing cores, or a central processing unit with more than one processing core.

One embodiment of the computing machine 500 includes a central processing unit 521 that communicates with cache memory 540 via a secondary bus also known as a backside bus, while another embodiment of the computing machine 500 includes a central processing unit 521 that communicates with cache memory via the system bus 550. The local system bus 550 can, in some embodiments, also be used by the central processing unit to communicate with more than one type of I/O devices 530a-530n, as well as various medical instruments 130, 132, 134, 136, 138. In some embodiments, the local system bus 550 can be any one of the following types of buses: a VESA VL bus; an ISA bus; an EISA bus; a MicroChannel Architecture (MCA) bus; a PCI bus; a PCI-X bus; a PCI-Express bus; or a NuBus. Other embodiments of the computing machine 500 include an I/O device 530a-530n that is a video display 524 that communicates with the central processing unit 521 via an Advanced Graphics Port (AGP). Still other versions of the computing machine 500 include a processor 521 connected to an I/O device 530a-530n via any one of the following connections: HyperTransport, Rapid I/O, or InfiniBand. Further embodiments of the computing machine 500 include a communication connection where the processor 521 communicates with one I/O device 530a using a local interconnect bus and with a second I/O device 530b using a direct connection.

Included within some embodiments of the computing device 500 is each of a main memory unit 522 and cache memory 540. The cache memory 540 will in some embodiments be any one of the following types of memory: SRAM; BSRAM; or EDRAM. Other embodiments include cache memory 540 and a main memory unit 522 that can be any one of the following types of memory: Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), or any other type of memory device capable of executing the systems and methods described herein. The main memory unit 522 and/or the cache memory 540 can in some embodiments include one or more memory devices capable of storing data and allowing any storage location to be directly accessed by the central processing unit 521. Further embodiments include a central processing unit 521 that can access the main memory 522 via one of either: a system bus 550; a memory port 503; or any other connection, bus or port that allows the processor 521 to access memory 522.

One embodiment of the computing device 500 provides support for any one of the following installation devices 516: a floppy disk drive for receiving floppy disks such as 3.5-inch, 5.25-inch disks or ZIP disks, a CD-ROM drive, a CD-R/RW drive, a DVD-ROM drive, tape drives of various formats, USB device, a bootable medium, a bootable CD, a bootable CD for GNU/Linux distribution such as KNOPPIX®, a hard-drive or any other device suitable for installing applications or software. Applications can in some embodiments include a client agent 520, or any portion of a client agent 520. The computing device 500 may further include a storage device 528 that can be either one or more hard disk drives, or one or more redundant arrays of independent disks; where the storage device is configured to store an operating system, software, programs applications, or at least a portion of the client agent 520. A further embodiment of the computing device 500 includes an installation device 516 that is used as the storage device 528.

Furthermore, the computing device 500 may include a network interface 518 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). One version of the computing device 500 includes a network interface 518 able to communicate with additional computing devices via any type and/or form of gateway or tunneling protocol such as Secure Socket Layer (SSL) or Transport Layer Security (TLS), or the Citrix Gateway Protocol manufactured by Citrix Systems, Inc. Versions of the network interface 518 can comprise any one of: a built-in network adapter; a network interface card; a PCMCIA network card; a card bus network adapter; a wireless network adapter; a USB network adapter; a modem; or any other device suitable for interfacing the computing device 500 to a network capable of communicating and performing the methods and systems described herein.

Embodiments of the computing device 500 can include any one of the following I/O devices 530a-530n: a keyboard 526; a pointing device 527; a mouse; a gesture-based remote control device; an audio device; trackpads; an optical pen; trackballs; microphones; drawing tablets; video displays; speakers; inkjet printers; laser printers; and dye-sublimation printers; or any other input/output device able to perform the methods and systems described herein. An I/O controller 523 may in some embodiments connect to multiple I/O devices 530a-530n to control the one or more I/O devices. Some embodiments of the I/O devices 530a-530n may be configured to provide storage or an installation medium 516, while others may provide a universal serial bus (USB) interface for receiving USB storage devices such as the USB Flash Drive line of devices manufactured by Twintech Industry, Inc. Still other embodiments of an I/O device 530 may be a bridge between the system bus 550 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 500 can connect to multiple display devices 524a-524n, in other embodiments the computing device 500 can connect to a single display device 524, while in still other embodiments the computing device 500 connects to display devices 524a-524n that are the same type or form of display, or to display devices that are different types or forms, e.g., one display can be a 56″ high-resolution main display while others can be standard video monitors and/or flat panel displays. Embodiments of the display devices 524a-524n can be supported and enabled by the following: one or multiple I/O devices 530a-530n; the I/O controller 523; a combination of I/O device(s) 530a-530n and the I/O controller 523; any combination of hardware and software able to support a display device 524a-524n; any type and/or form of video adapter, video card, driver, and/or library to interface, communicate, connect or otherwise use the display devices 524a-524n. The computing device 500 may in some embodiments be configured to use one or multiple display devices 524a-524n, these configurations include: having multiple connectors to interface to multiple display devices 524a-524n; having multiple video adapters, with each video adapter connected to one or more of the display devices 524a-524n; having an operating system configured to support multiple displays 524a-524n; using circuits and software included within the computing device 500 to connect to and use multiple display devices 524a-524n; and executing software on the main computing device 500 and multiple secondary computing devices to enable the main computing device 500 to use a secondary computing device's display as a display device 524a-524n for the main computing device 500. Still other embodiments of the computing device 500 may include multiple display devices 524a-524n provided by multiple secondary computing devices and connected to the main computing device 500 via a network.

In some embodiments of the computing machine 500, an operating system may be included to control task scheduling and access to system resources. Embodiments of the computing device 500 can run any one of the following operation systems: versions of the MICROSOFT WINDOWS operating systems such as WINDOWS 3.x; WINDOWS 95; WINDOWS 98; WINDOWS 2000; WINDOWS NT 3.51; WINDOWS NT 4.0; WINDOWS CE; WINDOWS XP; WINDOWS VISTA; and WINDOWS 7; the different releases of the Unix and Linux operating systems; any version of the MAC OS manufactured by Apple Computer; OS/2, manufactured by International Business Machines; any embedded operating system; any real-time operating system; any open source operating system; any proprietary operating system; any operating systems for mobile computing devices; or any other operating system capable of running on the computing device and performing the operations described herein. One embodiment of the computing machine 500 has multiple operating systems installed thereon.

The computing machine 500 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a device of the IPOD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In certain embodiments the computing machine 500 can be a mobile device such as any one of the following mobile devices: a JAVA-enabled cellular telephone or personal digital assistant (PDA), such as the i55sr, i58sr, i85s, i88s, i90c, i95c1, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein. Still other embodiments of the computing environment 101 include a mobile computing device 500 that can be any one of the following: any one series of Blackberry, or other handheld device manufactured by Research In Motion Limited; the iPhone manufactured by Apple Computer; any handheld or smart phone; a Pocket PC; a Pocket PC Phone; or any other handheld mobile device supporting Microsoft Windows Mobile Software.

In certain embodiments, the central processing station as described above functions as a client machine within a local area network or a wide area network. In some embodiments, the central processing station functions as a server in a local area network or a wide area network. Plural computers, servers and/or medical instruments can be in communication with the central processing station 110 through a local area network, medium area network, and/or a wide area network. An embodiment of a network 560 is depicted in FIG. 6C. It will be appreciated that any node of the network can be connected to another network, e.g., to a WAN, a MAN, or LAN.

When configured to function as a client machine, the central processing station 110 can in some embodiments execute, operate or otherwise provide an application that can be any one of the following: software; a program; executable instructions; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other type and/or form of executable instructions capable of executing on the central processing station 110. Still other embodiments may include a computing environment with an application that is any of either server-based or remote-based, and an application that is executed on a server 562a on behalf of the central processing station 110. Further embodiments of the computing environment include a server 562a configured to display output graphical data to the central processing station 110 using a thin-client or remote-display protocol, where the protocol used can be any one of the following protocols: the Independent Computing Architecture (ICA) protocol manufactured by Citrix Systems, Inc. of Ft. Lauderdale, Fla.; or the Remote Desktop Protocol (RDP) manufactured by the Microsoft Corporation of Redmond, Wash.

In one embodiment, the central processing station 110 can be a virtual machine such as those manufactured by XenSolutions, Citrix Systems, IBM, VMware, or any other virtual machine able to implement the methods and systems described herein.

The computing environment can, in some embodiments, include plural servers 562a, 562b, where the servers are: grouped together as a single server entity, logically-grouped together in a server farm; geographically dispersed and logically grouped together in a server farm, located proximate to each other and logically grouped together in a server farm. Geographically dispersed servers within a server farm can, in some embodiments, communicate using a wide area network (WAN), medium area network (MAN), or local area network (LAN), where different geographic regions can be characterized as: different continents; different regions of a continent; different countries; different states; different cities; different campuses; different rooms; or any combination of the preceding geographical locations. In some embodiments the server farm can be administered as a single entity or in other embodiments can include multiple server farms. The computing environment for the central processing station 110 can include more than one server grouped together in a single server farm where the server farm is heterogeneous such that one or a subgroup of servers is configured to operate according to a first type of operating system platform (e.g., WINDOWS NT, manufactured by Microsoft Corp. of Redmond, Wash.), while one or more other servers are configured to operate according to a second type of operating system platform (e.g., Unix or Linux).

In some embodiments, the central processing station 110 is located in a computing environment which includes one or plural servers configured to provide the functionality of any one of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server configured to operate as an active direction; a server configured to operate as application acceleration application that provides firewall functionality, application functionality, or load balancing functionality, or other type of computing machine configured to operate as a server. In some embodiments, a server can include a remote authentication dial-in user service such that the server is a RADIUS server. For embodiments of the computing environment where the server comprises an appliance, the server can be an appliance manufactured by any one of the following manufacturers: the Citrix Application Networking Group; Silver Peak Systems, Inc; Riverbed Technology, Inc.; F5 Networks, Inc.; or Juniper Networks, Inc. Some embodiments include a server with the following functionality: receives requests from a the central processing station 110, forwards the request to a second server, and responds to the request generated by the central processing station 110 with a response from the second server; acquires an enumeration of applications available to the client machines 564a, 564b within the network and address information associated with a server hosting an application identified by the enumeration of applications; presents responses to client requests using a web interface; communicates directly with the central processing station 110 to provide the central processing station 110 with access to an identified application; receives output data, such as display data, generated by an execution of an identified application on the server.

In certain embodiments, a server on the network, or the central processing station 110 functioning as a server, can be configured to execute any one of the following applications: an application providing a thin-client computing or a remote display presentation application; any portion of the CITRIX ACCESS SUITE by Citrix Systems, Inc. like the METAFRAME or CITRIX PRESENTATION SERVER; MICROSOFT WINDOWS Terminal Services manufactured by the Microsoft Corporation; or an ICA client, developed by Citrix Systems, Inc. Another embodiment includes a server configured to execute an application so that the server may function as an application server such as any one of the following application server types: an email server that provides email services such as MICROSOFT EXCHANGE manufactured by the Microsoft Corporation; a web or Internet server; a desktop sharing server; or a collaboration server. Still other embodiments include a server that executes an application that is any one of the following types of hosted servers applications: GOTOMEETING provided by Citrix Online Division, Inc.; WEBEX provided by WebEx, Inc. of Santa Clara, Calif.; or Microsoft Office LIVE MEETING provided by Microsoft Corporation.

In one embodiment, a server on the network, or the central processing station 110 functioning as a server may be a virtual machine such as those manufactured by XenSolutions, Citrix Systems, IBM, VMware, or any other virtual machine able to implement the methods and systems described herein.

It will be appreciated that the central processing station 110 may function, in some embodiments, as a client node seeking access to resources provided by a server 562a on the network, or as a server providing other clients 564a, 564b, and/or instruments 132, 134 on the network with access to hosted resources. One embodiment of the computing environment includes a server that provides the functionality of a master node. As an example, the central processing station 110 may communicate with other clients through the master node server. One embodiment of the computing environment includes the central processing station 110 that communicates over the network requests for applications hosted by a master server or a server in a server farm to be executed, and uses the network to receive from the server output data representative of the application execution.

In certain embodiments, a Linux kernel is installed on one or plural medical instruments 132, 134. The Linux kernel adapts the host instrument to communicate with and provide data to the central processing station 110 over the network 560. In certain embodiments, data is received from plural instruments hosting Linux kernels and handled by a video/data wall processor, e.g., Media Wall 2500 available from RGB Spectrum, within the central processing station. The wall processor can provide the functionality of a KVM switch. Data from the wall processor can be split with a digital repeater, e.g., a DVI-5314b available from DVI Gear, to provide data streams for a main display 120, streaming data for viewing over the network, and data for recordation. In certain embodiments, data for recordation is combined downstream with audio data before it is recorded.

The network 560 between the central processing station 110 and a server, client, and/or instrument is a connection over which data is transferred between the central processing station 110 and the server, client, or instrument. In various embodiments, the network connects the central processing station 110 with client machines, instruments, and/or servers. The network 560 can be any of the following: a local-area network (LAN); a metropolitan area network (MAN); a wide area network (WAN); a primary network comprised of multiple sub-networks located between the client machines and the servers; a primary public network with a private sub-network; a primary private network with a public sub-network; or a primary private network with a private sub-network. Still further embodiments include a network that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; a network that includes a wireless link where the wireless link can be an infrared channel or satellite band; or any other network type able to transfer data from the central processing station 110 to client machines and/or servers and vice versa to accomplish the methods and systems described herein. Network topology may differ within different embodiments, possible network topologies include: a bus network topology; a star network topology; a ring network topology; a repeater-based network topology; and a tiered-star network topology. Additional embodiments may include a network of mobile telephone networks that use a protocol to communicate among mobile devices, where the protocol can be any one of the following: AMPS; TDMA; CDMA; GSM; GPRS UMTS; or any other protocol able to transmit data among mobile devices to accomplish the systems and methods described herein.

It will be appreciated that the integration system 100 can provide for remote internet access via an internet modem 285 or network interface 518. In various embodiments, remote access via a LAN or WAN is used to operate the integration system 100, or to participate in viewing an ongoing medical procedure. In some embodiments, a remote participant can have video access, audio access, and optionally electronic chalkboard access to an integration system 100 in use at a distant facility. Remote audio access can be provided over an LAN, MAN, or WAN or telephone network. Remote access can be used to participate in a surgical procedure from a remote location, e.g., a specialist can monitor a case as it occurs and provide assistance from locations near or far removed from the operating room. In some embodiments, remote access is used to run diagnostics of the inventive integration system 100, or to upgrade software executed on the system. In some embodiments, remote access is used to review one or more surgical cases. In certain embodiments, the remote access is used for instructional purposes, e.g., for live observation of a complex surgical procedure by interns. In various embodiments, the inventive integration system 100 supports inter-frame data compression of data transmitted over a LAN, MAN, or WAN.

### IV. Aspects of Data Display

In various embodiments, the main high-resolution data display 120 comprises a high-resolution, large-screen, video display, e.g. a 56-inch, 8 megapixel flat panel monitor or the like. The display 120 can be located in an operating room or procedure room near an attending clinician. The display 120 provides multiple, high-quality images and data representations, e.g., charts, graphs, level indications, etc., derived from data produced by a plurality of medical instruments 130, 132, 134, 136, 138.

In some embodiments, at least one high-resolution display device 120 used with the system 100 comprises apparatus adapted to display a holographic image. The display device 120 can comprise a holographic projection system for projecting a three-dimensional image. The displayed holographic image can be projected by hologram technology to provide a three-dimensional (3D) representation of an organ or region of physical anatomy. In some embodiments, the displayed image can be a clinically generated image provided in 3D holographic format. The holographic image can be rotated, dissected and repositioned upon data command input to the system to aid in clinical diagnosis, treatment, and/or education.

As an example, system 100 can provide video data to display device 120 which generates a 3D holographic image of a patient's heart. The display can include representations of catheters used in a procedure on the heart, and provide a real-time visual guide to assist in the placement of the catheters as well as display the location of cardiac ablations. The display can provide a 3D mapping of the heart, and be manipulated at the discretion of the clinician. As an additional visual aid, selected cross-sectional views of the 3D image can be displayed substantially simultaneously on a second display device 120, e.g., a flat-panel, high-resolution video screen.

In certain embodiments, the system 100 is adapted to provide electronic chalkboard operation for one or plural video display devices 120, 205. In electronic chalkboard operation, a system user can electronically mark or annotate a feature on a display device 120 of the system so that others can view the marked or annotated feature on the same display or auxiliary displays in operation with the system 100. A system user can identify a particular item on a display with a pointer, draw circles, lines, arrows, words, etc. so that the markings are visible on all display devices 120, 205 in operation with the system. In some embodiments, the marking or annotation are made within a 3D holographic image.

Electronic annotation can be provided by an electronic, magnetic, optical, or electromagnetic marking device, such as a magnetic-tipped pen or optical diode pointer device. Additionally, electronic annotation can be provided via remote-control device 206. In some embodiments, markings and annotation are made with a motion-gesture or motion-sensing marking device, e.g., a device which provides data for electronic annotation on a display in response to movement of the device.

In some implementations, marking devices may communicate wirelessly with the video display 120. Each marking device may send a signal with the device's identification number to the central processing station 110. In some implementations, the identification number may correspond to the serial number of the marking device. In some implementations, the identification number may correspond to an identification number associated with a user of the integrated system 100.

In some embodiments, the integration system is adapted to provide multi-way electronic chalkboard operation. In multi-way electronic chalkboard operation, plural system users can electronically mark or annotate features on a display device. Each marking may be color coded to identify its creator. For example, the central processing station 110 may receive the identification number from a marking device. The station 110 may access a look-up table, database, or any other data structure to determine a color corresponding to the identification number of the marking device. Thus, as the station 110 receives annotations from the marking device, the station 110 may display the annotations in the color corresponding to the marking device. In certain embodiments, the integration system is configured such that one or a selected set of users can remove the markings or annotations.

Annotation marked on a display can be transient, semi-permanent, or permanent until erased. In some embodiments, where markings are made by a motion-gesture device, annotation is provided in a trace-then-write mode. As an example, a motion-gesture marking device can initiate display of a transient and faint or semi-transparent trace on one or plural system display devices 120, 205 as the marking device is moved. The trace can fade to no marking within about one second, within about one-half second, and yet within about one-quarter second in some embodiments. In certain embodiments, the persistence of the trace is adjustable by a system user to be any value between about two seconds and about one-tenth of a second. The fading trace can assist the operator in determining where a marking will be made on a display. In certain embodiments, when the trace arrives at a location where a more permanent marking is desired, an operator can push a button on the marking device to make semi-permanent, or permanent until erased, subsequent markings. Semi-permanent markings can persist on system display devices for time periods of any value, adjustable by a system operator, between about two seconds and about 10 minutes after which the markings will automatically fade to no marking. Markings can also be selected to be permanent until erased. Such markings remain on system displays until a command is issued to erase the annotations. The types of markings, e.g., transient, semi-permanent, permanent until erase, can be selected by push-button or voice commands. The annotations can be “push-button” or voice-command erasable, e.g., by pushing a button on the marking device or issuing a voice command to the system 100. The semi-permanent and permanent markings can be semi-transparent so as not to completely occlude image data behind a marking.

In some implementations, the station 110 may determine how long markings may persist on the video display 120 based at least in part on the identification number of the marking device. The station 110 may access a look-up table, database, or any other data structure to retrieve a period of time associated with the identification number of a marking device. When the station 110 receives annotations from the marking device, the station 110 may set the display of the annotations to fade within the period of time retrieved. In some implementations, the period of time may be between about 2.0 seconds and about 10.0 seconds.

In certain embodiments, a marking device or remote-control device 206 provides control of a pointer visibly displayed on one or plural display devices. The pointer can be permanently on or blinking, and moves in response to movement of the marking device. The pointer can be used to point to or draw attention to particular items on a display device 120. In some embodiments, the pointer is used in conjunction with a graphical user interface.

In various embodiments, annotations are used for assistance, instructional, oversight, clinical review, or analytical purposes. In certain embodiments, the system is adapted for two-way electronic chalkboard operation. As an example, a senior or first physician can be located in a control room or remote location while a second physician, e.g., another physician, fellow or Physician's Assistant, carries out an invasive procedure in an operating room or procedure room. The first physician can monitor the procedure and communicate with the second physician via audio and graphical mode, e.g., voice communication over the audio communication subsystem and annotations which are displayed on the main display device 120. The first physician can point to and identify specific items, e.g., features of anatomy, data displayed from various monitoring equipment, vital signs, etc., which are displayed on the main display 120. The first physician can make the annotations on an auxiliary display 205 located in the control room or remote location, yet these markings will be simultaneously displayed in the operating room. Additionally, the second physician can make annotations, via gesture-based marking, on the main display 120 in the operating room, which are simultaneously displayed on the auxiliary display located with the first physician.

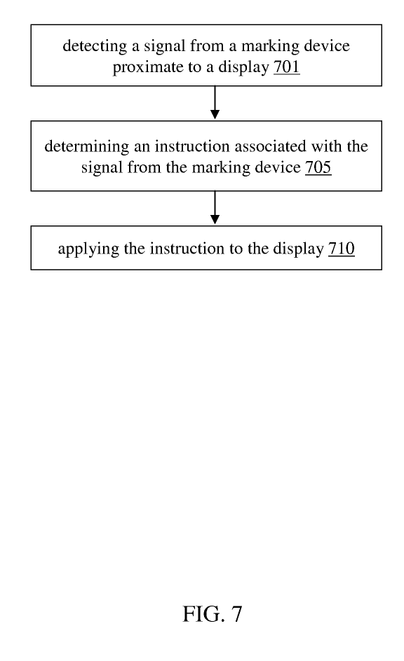

Referring now to FIG. 7, a method is shown and described. The method may include detecting a signal from a marking device proximate to a display (step 701). The signal may be detected by a display. The method may include determining an instruction associated with the signal from the marking device (step 705). The method may include applying the instruction to the display (step 710).

In various embodiments, the video processing engine 250 is in communication with the central processing unit 210 and can receive video display commands from the central processing unit. The video processing engine 250 can adjust the size of any displayed image, alter the color, contrast and/or brightness of any displayed image, adjust the position of any displayed image, and change the number and/or selection of displayed images in accordance with commands received from the central processing unit 210. In certain embodiments, the displayed images are “right sized,” e.g., automatically sized to substantially eliminate image voids in the high-resolution video display 120.

In various embodiments, the video processing engine 250 provides for video mixing and image layering. The video processing engine 250 can prepare for display on the high-resolution display 120, substantially simultaneously, up to 12 different data streams received from a plurality of medical instruments. In some embodiments, the video processing engine 250 prepares up to 16 different data streams for display on the high-resolution display 120. In certain embodiments, integration system provides for control and management of data streams from as many as 24 different sources. Each data stream can contain dynamic or static video image data, data associated with chart traces, as well as instrument status indicators. Groups of data displayed on the system's video display 120 can be changed by commands provided through a control console. Some instrument data can be dropped from the display and other instrument data added to the display based upon commands provided to the integration system. Additional data can be layered over any one image by the video processing engine. In some embodiments, the video processing engine 250 can enlarge and display a single image from one data stream at full-screen view, e.g., an image can be enlarged temporarily in response to a command from an attending physician. In some embodiments, an image can be enlarged temporarily on an automated basis in response to a cautionary status indicator received at the central processing unit 210 from a particular medical instrument.

In various embodiments, the images are displayed by the video processing engine 250 according to preset display configurations. For example, a user can select a particular group of medical instruments for which a video display is desired, and select a size for each of the displayed data-stream images. A user can compose several display configurations, and save parameters associated with each configuration in a system memory device 270. Any preset display configuration can be recalled upon start-up, or during operation of the inventive integration system 100. Preset configurations can be selected by providing an input into a touchpad 242, keyboard 202, mouse controller 204, or remote-control device 206, or by providing voice commands at an audio device 104. Accordingly, a user can rapidly toggle the display between a number of different preset display configurations. In some embodiments, the preset configurations are editable or customizable in real time, e.g., while the system is in use.

In some embodiments, the video processing engine 250 receives video input from an intermediary device, e.g., a KVM switch as depicted in FIG. 3. In some embodiments, the video processing engine 250 receives a plurality of video inputs indirectly, or directly, from medical instruments as depicted in FIG. 4. In some embodiments, video inputs are split and/or amplified prior to being fed into the video processing engine 250, or fed directly into the video processing engine. In certain embodiments, the video processing engine provides output for a single high-resolution display 120 and for a second auxiliary or back-up display. The second display can be located in a partitioned control room, or can be located within the operating room. In some embodiments, video displays from existing equipment, e.g., biplane fluoroscopy displays, are retained and/or paired with the high-resolution display 120. The retained displays can provide back-up imaging security, or free up imaging space on the high-resolution display.

In some implementations, the integration system 100 may detect a medical instrument 130 that has become proximate to a central processing station 110. Upon detection of the medical instrument 130, the central processing station 110 may determine that data from the medical instrument 130 should be displayed on the video-display device 120. The central processing station 110 may transmit data from the medical instrument 130 to the video processing engine 250 for display on the video-display device 120.

A medical instrument 130 may broadcast a signal that the central processing station 110 may use to determine the presence of the medical instrument. In some implementations, the medical instrument 130 may broadcast the signal on a substantially continuous basis. In some implementations, the medical instrument 130 may broadcast the signal on a substantially periodic basis. For example, the medical instrument 130 may broadcast the signal when a predetermined period of time elapses (e.g., every 10 seconds, every 30 seconds).

In some implementations, the medical instrument 130 may broadcast the signal in response to a request from a central processing station 110. The central processing station 110 may broadcast a signal that requests a response from any medical instrument 110 that receives the signal. In some implementations, the central processing station 110 may broadcast the signal on a substantially continuous basis. In some implementations, the central processing station 110 may broadcast the signal on a substantially periodic basis, e.g., when a predetermined period of time elapses (e.g., every 10 seconds, every 30 seconds). In response to the signal received from the central processing station 110, the medical instrument 130 may broadcast a signal that the central processing station 110 may use to determine the presence of the medical instrument 130.

In some implementations, the medical instrument 130 may broadcast a wireless signal. In some implementations, the medical instrument 130 may include a radio frequency device (RFID) that broadcasts a radio frequency identification signal. The RFID device may be an active RFID device. The RFID device may be a passive RFID device. In some implementations, the passive RFID device may remain inactive until receipt of a signal from the central processing station 110. The signal may activate the passive RFID device. The signal may power the passive RFID device. The passive RFID device may use the power from the signal to broadcast a signal that the central processing station 110 may use to determine the presence of the medical instrument 130.

In some implementations, the medical instrument 130 may include a Wi-Fi device that broadcasts a Wi-Fi signal. In some implementations, the medical instrument 130 may include a Bluetooth device that broadcasts a Bluetooth signal. In some implementations, the medical instrument 130 may include a device that broadcasts an infrared (IR) signal. In some implementations, the medical instrument 130 may include a device that broadcasts an ultrawideband (UWB) signal. In any of these implementations, the central processing station 110 may include a device adapted to detect a radio frequency identification signal, a Wi-Fi signal, a Bluetooth signal, an infrared signal, an ultrawideband signal, or any combination thereof.

In some implementations, the medical instrument 130 may communicate with a remote server (not shown) over a telecommunications network (e.g., 3G network, 4G network). The medical instrument 130 may transmit a signal over the telecommunications network to the remote server. The signal may include information about the medical instrument 130 (e.g., the location of the medical instrument 130). In some implementations, the remote server may transmit a signal over the telecommunications network to the central processing station 110. For example, the remote server may transmit a signal that includes information regarding the location of the medical instrument 130. In some implementations, the central processing station 110 may determine the medical instrument 130 is proximate by, for example, comparing the distance between the location of the central processing station 110 and the location of the medical instrument 130 with a location threshold. If the distance is smaller than the location threshold, the central processing station 110 may determine that data from the medical instrument 130 shall be displayed on the video-display device 120.

The signal broadcast by the medical instrument 130 may include information about the medical instrument 130. The information about the medical instrument 130 may be positioned in a predetermined field in the signal. For example, the information may be positioned in the third byte of information transmitted in the signal, although any other position may be used. In some implementations, the signal may include information to enable the signal to be received via the central processing station 110 (e.g., information to enable compatibility with a protocol for signal transmission and/or receipt).

In some implementations, the signal may include an identification number of the medical instrument 130. The identification number may be a serial number of the medical instrument 130. The identification number may be a code assigned to the medical instrument 130 by, for example, an administrator of the integration system 100. For example, the integration system 100 may use a numbering system to account for the medical instruments 130. If the integration system 100 accounts for 250 medical instruments, by way of example, each medical instrument may be assigned a number between 1 and 250. In some implementations, the identification number may be a code associated with a type of device. For example, a medical instrument 130 may store a code associated with an x-ray machine, an x-ray image intensifier, an ultrasound machine, a hemodynamic system, a c-arm, or any other type of medical device.

The central processing station 110 may parse the information in the signal broadcast by the medical instrument 130 to determine the identification number. In some implementations, the station 110 may access the extended display identification data (EDID) in the signal to determine the identification number.

In some implementations, the central processing station 110 may use the identification number to determine a location on the video-display device 120 in which data from the medical instrument 130 may be displayed. For example, the central processing station 110 may allocate a set of pixels on the frame buffer for the video-display device 120 to a window, and data received from a medical instrument 130 may be displayed in the window for the frame buffer. The set of pixels may correspond to an array of pixels. The central processing station 110 may allocate different sets of pixels on the frame buffer to different windows, and data received from the medical instruments may be displayed in the different windows. In some implementations, each window on the frame buffer may have the same dimensions (e.g., same width and same height). In some implementations, the windows on the frame buffer may have different dimensions.

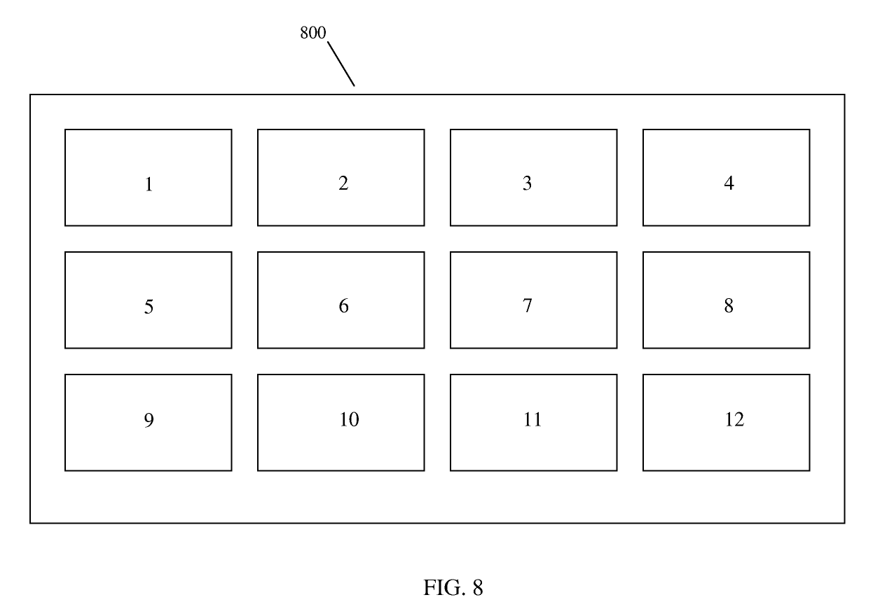

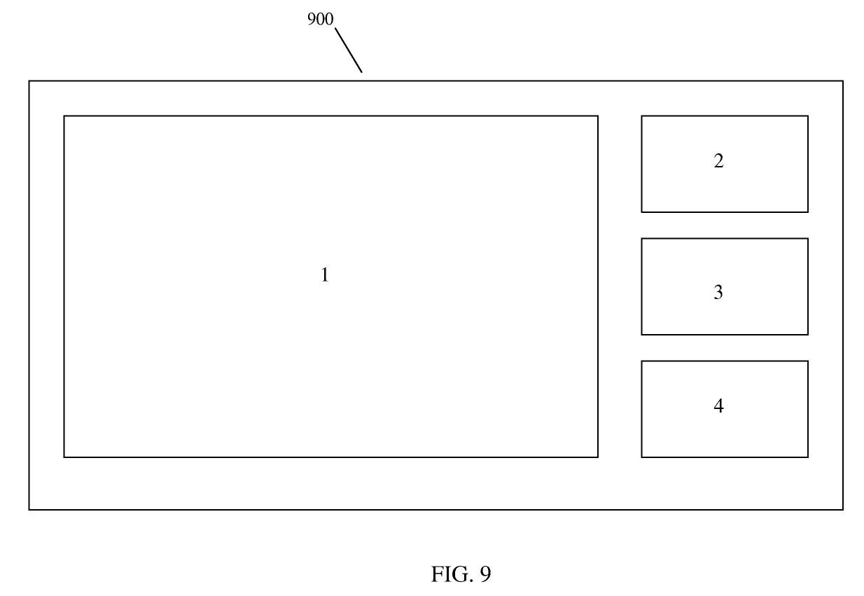

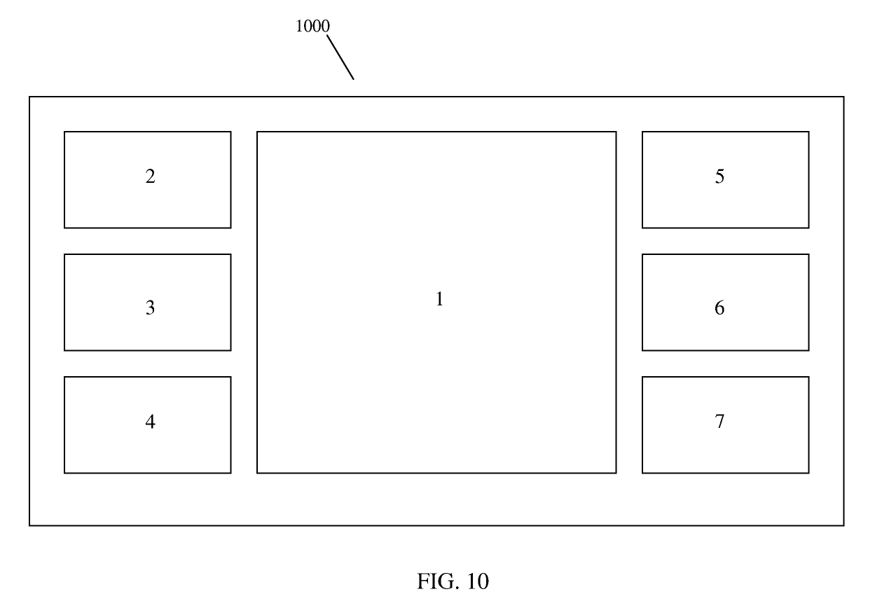

The windows may be arranged on the frame buffer in any manner desired by one of ordinary skill in the art (e.g., according to any display configuration). For example, when the windows have the same dimensions, the windows may be arranged in a grid, as exemplified in the display 800 shown in FIG. 8. In another example, one window may have larger dimensions than all the other windows. The large window may be a main window, and the other windows may be arranged in an adjacent grid, as exemplified in the display 900 shown in FIG. 9. In another example, the large window may be a main window, and the other windows may be arranged in grids adjacent to the large window, as exemplified in the display 1000 shown in FIG. 10.

In some implementations, each window may be numbered, as exemplified in the displays shown in FIGS. 8-10. Each window may be associated with a type of device. For example, the window numbered “1” may be associated with robotic catheter manipulation systems. For example, the window numbered “2” may be associated with reconstruction workstations. For example, the window numbered “3” may be associated with ultrasound machines. For example, the window numbered “4” may be associated with x-ray machines. Any association between numbered windows and types of devices may be used.

The central processing station 110 may use the identification number to determine the window for displaying data from the medical instrument 130. In some implementations, the central processing station 110 may apply a formula to the identification number to determine the window. For example, the integration system 100 may account for 250 medical instruments, each instrument being assigned a number between 1 and 250. Instruments assigned a number between 1 and 24 may be associated with the window numbered “1,” instruments assigned a number between 25 and 37 may be associated with the window numbered “2,” instruments assigned a number between 38 and 56 may be associated with the window numbered “3,” instruments assigned a number between 57 and 81 may be associated with the window numbered “4,” and so on. Any other associations between windows and any groupings of the medical instruments may be used.

In some implementations, the central processing station 110 may access a stored entry corresponding to the medical instrument 130 to determine the window for displaying data received from the medical instrument 130. For example, the central processing station 110 may use the medical instrument's 130 identification number as an index into a database, look-up table, or any other entity or data structure that may be used to store relationships between data. In some implementations, the central processing station 110 may access a database and/or look-up table stored on a computing device. The central processing station 110 may communicate with the computing device over a communication link 115.

In some implementations, when the medical instrument's identification number is its serial number, the serial number may be used as an index into a look-up table. The entry corresponding to the instrument's serial number may identify the window for displaying data received from the instrument 130. In some implementations, when the medical instrument's identification number is a code associated with a type of device (e.g., a type of medical instrument), the code may be used as an index into a look-up table. The entry corresponding to the instrument's code may identify the window for displaying data received from the instrument 130 due to its type of device.

In some implementations, the central processing station 110 may access multiple stored entries to determine the window for displaying data received from the instrument 130. For example, when the medical instrument's identification number is its serial number, the serial number may be used as an index into a look-up table. The entry corresponding to the instrument's serial number may include a code indicating the instrument's type of device. The code may be used as an index into another look-up table. The entry corresponding to the code may identify the window for displaying data received from the instrument 130.

The central processing station 110 may determine if data from another medical instrument is already being displayed in the window. For example, the central processing station 110 may store a look-up table, or any other data structure, that tracks the medical instruments whose data are being displayed in the windows. The station 110 may use the window's number as an index into the table. The entry associated with the number may include the identification number of the medical instrument whose data is being displayed in the window. The station 110 may retrieve the entry corresponding to the window. If the entry includes a null symbol, the station 110 may not be displaying data from any instrument in the window. Thus, the station 110 may display data from the medical instrument 130 in the window.

In some implementations, the entry may include the identification number of another medical instrument whose data is being displayed in the window. In response, the central processing station 110 may request that the user of the station 110 select the medical instrument whose data the user wishes to see displayed. For example, the central processing station 110 may display a graphical user interface on the video-display device 120 that lists the identification numbers of the medical instruments (e.g., the serial numbers). The user may touch an icon on the display 120 corresponding to an identification number. In some implementations, the user may operate a control console 102 to select an instrument. For example, the user may operate a control console 102 to select an instrument from a drop-down menu. The central processing station 110 may display data from the selected medical instrument in the window.

In some implementations, when the station 110 is already displaying data from another medical instrument in the window, the central processing station 110 may compare the priority levels of the medical instruments. The central processing station 110 may access entries in another look-up table, or any other data structure, using the identification numbers of the medical instruments as indices. The central processing station 110 may retrieve the priority levels of the medical instruments from the table. The central processing station 110 may compare the priority levels. In some implementations, if the priority level of the newly detected medical instrument 130 is higher than the priority level of the instrument whose data is being displayed in the window, the central processing station 110 may automatically display data from the newly detected medical instrument 130 instead of data from the already detected medical instrument.

In some implementations, if the priority level of the instrument whose data is being displayed is higher, the station 110 may continue displaying data from the instrument whose data is already being displayed. The station 110 may display a notice to the user indicating that the data from the newly detected medical instrument 130 will not be displayed. In some implementations, the station 110 may allow the user to override the station's 110 decision to continue displaying data from the same medical instrument. For example, the notice may include a question regarding the medical instrument whose data should be displayed. The user may select an icon on a touchscreen display 120 corresponding to a medical instrument 130. The user may operate a control console 102 to select an instrument, as described herein.

In some implementations, the central processing station 110 may configure the frame buffer of the video display 120 according to one of a plurality of display configurations, such as the displays depicted in FIGS. 8-10. A user of the station 110 may select a display configuration according to any of the methods described herein. In some implementations, the central processing station 110 may store a look-up table, or any other data structure, that tracks the medical instruments whose data is being displayed, the windows in which the data is being displayed, and/or the priority levels of the medical instruments.

In some implementations, windows of a display configuration may be ranked. For example, data from a medical instrument with the highest priority level may be displayed in the window numbered “1,” data from a medical instrument with the next highest priority may be displayed in the window numbered “2,” and so on. In another example, data from a medical instrument with the highest priority level may be displayed in a main window, such as the window numbered “1” in the configuration displayed in FIG. 9. The other windows may not be ranked.

In some implementations, when the central processing station 110 determines the presence of a medical instrument 130, the station 110 may use the instrument's identification number to determine a priority level of the instrument 130. For example, the station 110 may use the identification number as an index into a table, or any other data structure, to access an entry with the instrument's 130 priority level. When the identification number is the instrument's serial number, the entry corresponding to the serial number may include the instrument's priority level. When the identification number is a code associated with a type of device, the code may be used as an index into a look-up table. The entry corresponding to the code may include the priority level.

In some implementations, the central processing station 110 may access multiple stored entries to determine a priority regarding display of data of the medical instrument 130. For example, when the medical instrument's identification number is its serial number, the serial number may be used as an index into a look-up table. The entry corresponding to the instrument's serial number may include a code indicating the instrument's type of device. The code may be used as an index into another look-up table. The entry corresponding to the code may include a priority level regarding display of data from that type of device, and hence, the priority level regarding display of data from the medical instrument 130.

In some implementations, the central processing station 110 may determine that at least one window on the display configuration is not associated with a medical instrument. For example, the station 110 may access the entries in the table, or any other data structure, that stores the relationships between windows and medical instruments. If an entry in the table includes a null symbol, or any other symbol indicating the window is not associated with a medical instrument, the station 110 may associate the medical instrument 130 with the window (e.g., the station 110 may insert the instrument's 130 identification number into the entry). The station 110 may display data received from the instrument 130 in the window.

The station 110 may determine that each window in the display configuration is associated with a medical instrument. The central processing station 110 may compare the priority level of the newly detected medical instrument 130 with the priority levels of instruments whose data is being displayed on the video display 120. In some implementations, the station 110 may determine if the priority level of the medical instrument 130 exceeds the priority level of any of the instruments whose data is being displayed. If the priority level does not, the station 110 may display a notice to the user indicating that data from the instrument 130 may not be displayed.

In some implementations, the station 110 may allow the user to override the station's 110 decision not to display data from the medical instrument 130. For example, the notice may include a question regarding display of data from the newly detected medical instrument 130. The user may select an option for the station 110 to display the data. Among the medical instruments whose data is being displayed, the station 110 may identify the instrument with the lowest priority level. The station 110 may identify the window associated with the medical instrument. In some implementations, the station 110 may display data received from the newly detected medical instrument 130 in lieu of data from the other medical instrument. The station 110 may store the identity of the displaced medical instrument. If the station 110 no longer detects data from the medical instrument 130, the station 110 may resume displaying data from the previously displaced medical instrument.

In some implementations, the detected medical instrument 130 may have a higher priority level than at least one medical instrument whose data is being displayed. If the instrument 130 has a higher priority than all the medical instruments whose data are being displayed, the station 110 may display data from the instrument 130 in the highest ranked window on the display configuration (e.g., the window numbered “1”). If the remaining windows in the display configuration are ranked, the central processing station 110 may shift the windows in which data from each instrument is displayed (e.g., the data previously displayed in the window numbered “1” may be displayed in the window numbered “2,” and so on).

In some implementations, if the remaining windows in the display configuration are not ranked, the central processing station 110 may identify the medical instrument with the lowest priority level and its associated window. The central processing station 110 may display data from the instrument previously displayed in the window numbered “1” in the window associated with the lowest ranked medical instrument. In this manner, data from the lowest ranked medical instrument may no longer be displayed, in favor of medical instruments with higher priority levels.

In some implementations, when all the windows on a display configuration are displaying data from medical instruments, the central processing station 110 may retrieve a different display configuration with at least one more window. Thus, data from all medical instruments currently being displayed and data from the newly detected medical instrument may be displayed. In some implementations, the central processing station 110 may retrieve a different display configuration based at least in part on the current display configuration being used. For example, if the station 110 is currently using a display configuration such as the configuration depicted in FIG. 8, the station 110 may retrieve a display configuration with an additional row or column of windows. For example, if the station 110 is currently using a display configuration such as the configuration depicted in FIG. 9, the station 110 may retrieve a display configuration with an additional column of smaller windows. The additional column may be positioned on either side of the main window. In some implementations, the station 110 may display thumbnails of suggested alternative display configurations, and the user may select one of the configurations.

Once the central processing station 110 has retrieved a different display configuration, the station 110 may display data from the medical instruments in the windows. In some implementations, the station 110 may re-order the medical instruments, including the newly detected instrument 130, according to their priority levels and assign each medical instrument its correspondingly ranked window in the display configuration. In some implementations, the station 110 may assign the newly detected medical instrument 130 to a window whose numbering did not appear on the previously used display configuration. The station 110 may display data from the medical instruments on the window of the frame buffer and thus, on the video display 120.

In some implementations, the central processing station 110 may receive data for display from the medical instrument 130. The central processing station 110 may receive the data via a wireless signal. In some implementations, the medical instrument 130 may transmit the data for display via the communication channel established between the instrument 130 and the station 110 when the station 110 received the signal broadcast for determining the presence of the medical instrument 130.

For example, the medical instrument 130 and the station 110 may have established a Wi-Fi communication channel when the medical instrument 130 broadcast a Wi-Fi signal for the station 110 to determine the instrument's 130 presence. Upon determining the instrument's presence, the central processing station 110 may transmit a request for data for display to the medical instrument 130 over the Wi-Fi communication channel. In response, the medical instrument 130 may transmit data for display to the central processing station 110 via wireless signal(s) on the Wi-Fi communication channel. In some implementations, the medical instrument 130 may broadcast an RFID signal with the instrument's identification number. The central processing station 110 may broadcast an RFID signal to acknowledge receipt of the instrument's identification number. In response, the medical instrument 130 may transmit radio frequency signals with data for display to the central processing station 110.

In some implementations, the medical instrument 130 may transmit the data for display using a separate communication channel from the channel used to broadcast the signal for determining the instrument's 130 presence. For example, the medical instrument 130 may broadcast an RFID signal with the instrument's identification number. In some implementations, the central processing station 110 may broadcast an RFID signal to acknowledge receipt of the instrument's identification number. In response, the medical instrument 130 may establish a Wi-Fi communication channel with the central processing station 110 and transmit data for display via wireless signal(s) on the Wi-Fi communication channel. In some implementations, in response to the RFID signal to acknowledge receipt, the medical instrument 130 may transmit data for display to a remote server over a telecommunications network (e.g., 3G network, 4G network). The remote server may transmit the data for display to the central processing station 110.

In some implementations, the medical instrument 130 may transmit image data. For example, the instrument 130 may transmit an image data stream. In some implementations, the medical instrument 130 may transmit video data for display. For example, the instrument may transmit a video stream. In some implementations, the medical instrument 130 may transmit audio data to be output concurrently with the image and/or video data.

In some implementations, the medical instrument 130 may transmit data for display in response to a request for data. The request may be a request for image data, video data, or any other type of data. The request may be from the central processing station 110. In some implementations, the signal that the central processing station 110 broadcasts to acknowledge receipt of the instrument's identification number may be interpreted by the medical instrument 130 as the request for data.

In some implementations, the central processing station 110 may transmit a signal to request the data. The signal may request an image format of the data. In response, the medical instrument 130 may process the data according to the image format and send the data in the image format to the central processing station. In some implementations, the central processing station 110 may transmit a request for data in a first image format and a later request for data in a second image format. For example, the central processing station 110 may transmit a request for data in Joint Photographic Experts Group (JPEG) format. In response, the medical instrument 130 may process the data according to the JPEG format and transmit the data in the JPEG format to the central processing station 110. At a subsequent time, the central processing station 110 may transmit a request for data in Tagged Image File Format (TIFF, or TIF). In response, the medical instrument 130 may process the data according to TIFF and transmit the data in the TIF format to the central processing station 110.

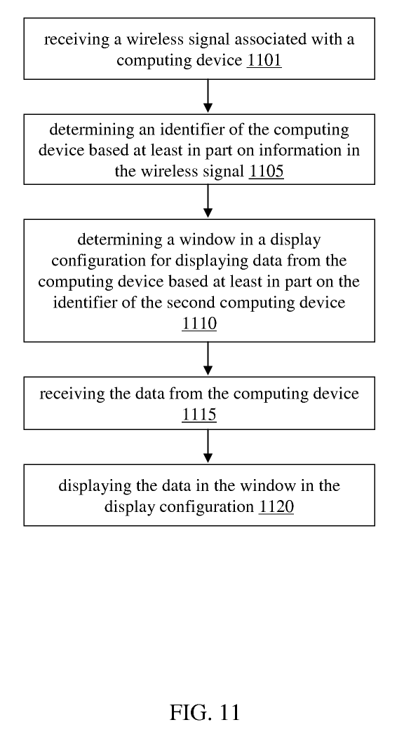

Referring now to FIG. 11, an flow diagram of an exemplary method is shown and described. The method may include receiving a wireless signal associated with a computing device, such as a medical instrument (step 1101). The method may include determining an identifier (e.g., an identification number) of the second computing device based at least in part on information in the wireless signal (step 1105). The method may include determining a window in a display configuration for displaying data from the computing device based at least in part on the identifier of the second computing device (step 1110). The method may include receiving the data from the computing device (step 1115). The method may include displaying the data in the window in the display configuration (step 1120).

### V. Audio Communication Subsystem

In various embodiments, the inventive integration system 100 includes an audio communication subsystem. The audio communication subsystem can be a multi-way, high-fidelity system providing multi-way audio communications between members using the integration system. The audio communication subsystem can comprise an audio communication board 280 in communication with one or plural audio communication devices 104. An audio communication device can be an audio sensor, e.g., microphone, or indicator, e.g., speaker, ear jack, or a combination sensor and indicator, such as a wireless head set. An audio communication device 104 can be operated by each member of an attending surgical team. In certain embodiments, the audio communication subsystem provides whisper-sensitive, recordable, and private wireless communications for up to 16 participants. Communication links between different audio devices and the audio communication board 280 can be wired or wireless. In some embodiments, the communication links are established via wireless RF signals. In various aspects, any one of the attending team members can remain in constant communication with the surgical team, even though departing from the operating room. In various embodiments, audio communications are handled and/or processed by the audio communication board 280. In some embodiments, audio communications are passed to the central processing unit 210 for storage in memory, e.g., storage in memory device 270.

In various embodiments, the audio communication subsystem eliminates the need for a room-wide intercom system, e.g., a intercom system between the operating room and a partitioned or remote control room. Such a room-wide system can be loud and distracting or disturbing to team members and non-sedated patients. Additionally, the room-wide intercom system is public. In various embodiments, the audio communication subsystem for the inventive integration system 100 provides high-fidelity, whisper-sensitive, private communications among team members. The audio communication devices 104 can be operated in push-to-talk mode or full duplex mode at the user's preference. In various embodiments, audio signals from any of the team members is delivered to all participants. In various embodiments, the audio communication subsystem provides hands-free operation between all participants in the operating room and in a partitioned or remote control room.

In certain embodiments, the audio system further provides for the inclusion of background music. In some cases, background music can be soothing to a patient, and beneficial to an attending surgeon. In various embodiments, a background music signal can be added to the audio signal delivered to any one or all participants. In some embodiments, background music is provide to public speakers within the facility and not to audio devices 104 in use by system users. In various aspects, the audio communication subsystem accepts audio input from compact disc players, MP3 players, portable music-storage devices, or internet music servers.

### VI. Data Recordation

In various embodiments, the inventive integration system 100 provides for integrated recording of data associated with a surgical case. Any or all of the plural types of data generated by medical instruments 130, 132, 134, 136, 138, data produced through audio communication devices 104, and user input commands from peripheral controls 202, 204, 242 can be integrated into a single, synchronized, common data stream. This data can be monitored by the central processing unit 210 and stored in memory device 270. In certain embodiments, the synchronized data stream is indexed as it is stored.

An advantage of the inventive integration system 100 is that all data can be stored as a common data stream, and subsequently retrieved, from a central database. An additional advantage is that all data can be stored synchronously, as it happens, such that it can later be reviewed as it would be perceived at the time of its original occurrence. It will be appreciated that synchronous data storage of an integrated, common data stream in a central database greatly reduces data-handling tasks that would be associated with retrieving and reviewing data from a plurality of different medical instruments. The integration of data provided by the inventive system 100 provides an advantage in data handling, management, and retrieval that extends beyond a simple combination of the plurality of medical instruments.

In certain embodiments, voice commands are used to mark or index data for storage, and facilitate subsequent retrieval. For example, significant events that occur during a surgical procedure can be marked by a voice command from the team leader. A voice command received from an audio communication board 280 can cause the central processing unit 210 to associate a searchable index at a particular location in a data stream as the data is stored. In some embodiments, time stamps can be associated with the data stream as it is stored. In certain embodiments, the data stream is indexed on an automated basis by software executing on the central processing station 110, or can be indexed manually by a team member. In various embodiments, the data is retrievable, searchable and reviewable according to an index, and/or according to associated time stamps or index markings.

In various embodiments, data stored by the inventive integration system 100 provides an accurate and realistic representation of actual surgical case, and can be used subsequently for instructional purposes or diagnostic purposes. In certain embodiments, the synchronously and centrally stored data is useful for subsequent computational and/or statistical analysis. In various embodiments, data warehouses are compiled for similar surgical cases, and software used to analyze data from a plurality of recorded cases. In various embodiments, the synchronized data is provided for computer and/or statistical analysis.

### VII. Instructional Code and Modes of Operation

In various modes of operation of the inventive integration system 100, customized or customizable software is executed on the central processing unit 210. The software can provide for communications and data exchange between medical instruments 130, 132, 134, 136, 138, audio devices 104, peripheral controls 202, 204, 206, 242, memory devices 270, and other associated hardware, e.g., KVM switch 220, wall processor, video processing engine 250, wireless communication modem 290, touchpad controller 240, audio communication modem 280, internet modem 285, in communication with the central processing unit 210. The software can provide for rapid customization of the inventive integration system for different or unique hardware configurations, e.g., additional or fewer medical instruments, medical instruments with non-standard data formats and communication protocols, additional or fewer peripheral devices, and additional, fewer, or novel hardware components in use with the integration system 100.

In various embodiments, proprietary software or firmware provides graphical user interface control for operation of all medical instruments, data management, data recording, and data display. In some embodiments, the software provides for touchpad control, e.g., displays buttons or selections on one or plural remote touchpad controllers 242, and/or remote control via gesture-based or voice-recognition control technology. In certain embodiments, the software generates dashboard images or display widgets on a peripheral control screen or on the main high-resolution video display 120. In certain embodiments, a dashboard image displays a customizable extract of selected data or information. In some embodiments, the software provides an integrated audit trail for each surgical case, and can code or mark case data for efficient retrieval and review. In some embodiments, the software includes analytical routines to numerically evaluate data recorded for one or plural surgical cases, and compile statistical data from the evaluation. In some embodiments, analysis of data is carried out during a complex surgical procedure. In various embodiments, the software provides comparison of pre-case data and post-intervention data. Data comparisons can be displayed and reviewed on the main display 120 at any time during or after surgical procedures. The comparison of pre-intervention and post-intervention data can provide a rapid and convenient indication of success of the procedure.

In some embodiments, software or firmware in operation on the central processing unit 210 can enable and disable electronic chalkboard operation on system displays 120, 205. As an example, software executing on the processing unit 210 provides an “annotation” icon on any one or plural of system displays and/or control panels. When a clinician or system operator selects the icon, the software provides for electronic chalkboard operation, as described above, to allow a clinician or system operator to make markings on a system display device 120, 205.

In certain embodiments, computer code or software or firmware is provided to allow a physician or system operator to facilely customize and control operational aspects of the integration system 100, such as imaging parameters, data recording and data display. The software applications can be compatible with popular personal electronic devices, e.g., Apple iPhone, iPod-Touch or any other handheld PDA, etc. The software applications can allow a clinician to design multiple “preset” configurations and/or identify any one configuration to alter operational aspects of the integration system 100, e.g., data and image selection, video display layout, image location and size, medical instrument parameters, etc. The preset configurations can be designed, identified, and stored in memory on personal electronic device, ready for downloading and use with the integration system 100. The clinician or system operator can “dock” the personal electronic device in a docking station associated with the integration system 100, or wirelessly “dock” it via Bluetooth connection or any wireless communication connection. In this manner, the system can be adapted to receive operational data from a personal electronic device. Any one of plural preset configurations can then be selected during operation of the integration system 100 and provide for rapid reconfiguration of the integration system. A selected preset configuration can substantially immediately change the operating parameters of the integration system 100 in accord with data provided from the personal electronic device corresponding to the selected preset configuration. A clinician or system operator can scroll through various preset configurations, at will, to change operational aspects of the integration system 100 as needed. In some embodiments, a personal electronic device can be interfaced with the inventive system 100 to provide an active and removable touch-panel display, which provides user preferred system configurations. In some embodiments, a personal electronic device is suitably adapted with software applications operating therein to provide a “universal” remote controller for the integration system 100, e.g., for controlling the functions of the actual clinical equipment that is generating original clinical data such as digital data, images, audio recordings, etc.

In various embodiments, software and/or firmware executing on the central processing unit 210 includes one or plural self-diagnostic routines. A self-diagnostic routine can monitor the status of all electronic equipment while in use, and display one or plural status indicators on a control monitor or on a main display 120. The one or plural status indicators can be associated with each instrument in communication with the integration system, a group of instruments, software in operation on the system, or the entire system. In some embodiments, the self-diagnostic routines monitor the operational status of equipment, e.g., power status, internal processor status, communication status, etc. In some embodiments, the self-diagnostic routines monitor the status of data recorded by equipment, e.g., heart rate status, blood pressure status, respiration rate status, blood oxygenation status, etc. The self-diagnostic routines can be executed periodically. In various embodiments, any monitored status detecting a fault can trigger a cautionary or warning signal when the monitored status goes into a cautionary state, e.g., low power, loss of communication, low heart rate, low blood oxygenation. The cautionary or warning signal can be presented on audio, video, or a combination thereof, and designed to draw the attention of one or more attending team members. In some embodiments, various cautionary or warning signals are delivered only to certain designated team members, so as to reduce unnecessary distractions to other team members. In some embodiments, the warning signal comprises a temporary alteration of video images on the main display 120, e.g., one image can be enlarged to cover a larger portion of the display while other images reduced, or an image can be overlayed temporarily on top of other images, with or without transparency, or an image or portion of an image can be highlighted or emphasized, or large text can be overlayed on at least a portion of the display 120. In some embodiments, displayed images on the main video display 120 are rearranged as a result of detection of a fault.

In some embodiments, the software and/or firmware executing on the inventive integration system 100 routinely runs maintenance self-diagnostic tests while the operating room is not in use. The maintenance tests can include evaluating the operational status of each medical instrument in communication with the integration system 100, evaluating communication links 115, 140, 108 used by the system, and evaluating the operational status of each system component, e.g., internal boards, peripheral controls, video display, etc. In some embodiments, the maintenance self-diagnostic tests can detect or initiate instrument failure while the operating room is not in use, and provide a maintenance notification so that the system can be repaired by qualified personnel prior to its next scheduled use.

In certain embodiments, the software executing on the inventive integration system 100 includes an imaging display back-up procedure. For example, should the main high-resolution display 120 fail during use, an imaging back-up procedure can sense the display failure, and automatically reroute all displayed data to an auxiliary back-up monitor, or to a set of auxiliary back-up monitors.

In some embodiments, the inventive system 100 supports “mission critical” operation. In mission critical operation, failsafe computer routines provide substantially immediate replacement and continuation of displayed data should any equipment or software component of the system 100, which is identified as critical to the successful completion of an entire procedure, fail for a period of time between about 0.1 second and about 2 seconds, between about 0.1 second and about 1 second, and yet between about 0.1 second about 0.5 second in certain embodiments. The critical equipment and software components can be identified as such to software in operation on the system 100 by a system operator prior to the initiation of a procedure. In certain embodiments, critical equipment and software components are identified and retained in system software settings associated with particular procedures. The settings can be retained in or included with preset configurations. During a procedure, equipment redundancy and mirroring of data can be utilized to provide substantially immediate replacement and continuation of displayed data should any critical equipment or software component fail for a period of time. In certain embodiments, the system provides firewalls that have real time mirror imaging of data transfers and/or collections. Software toggles and data switches can provide for activation of redundant equipment in the event of primary equipment failure, and routing of data from the redundant equipment to the main display 120. In some embodiments, self-diagnostic routines in execution on the system 100 monitor the status of all system components and determine whether critical equipment and software components are operating properly or in failure mode. When failure mode is detected by the self-diagnostic routine, back-up procedures can be initiated.

In various embodiments, software in operation on the system 100 provides video enhancement algorithms. For example, a video enhancement algorithm can allow a system operator to dim certain parts of the video display and brighten a region of interest. The software can provide for alterations of color, contrast, brightness, saturation, hue, edge resolution, and the like, to enhance a visual display. In various embodiments, the software provides downstream video enhancement of source video images.

### VIII. Wireless Communication

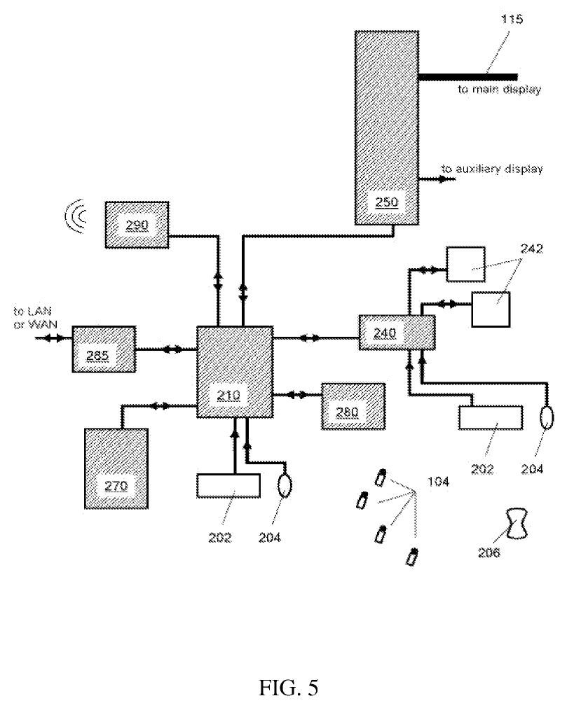

Referring now to FIG. 5, one embodiment of the inventive integration system 100 includes wireless communication between one or plural medical instruments and a wireless modem or communication board 290. In various embodiments, the wireless communication comprises an RF communication link. In certain embodiments, all data from one or plural medical instruments is communicated over the wireless link, and sent to the video processing engine 250. In some embodiments, some data from one or plural medical instruments is communicated over the wireless link, and video data is sent directly from each medical instrument via a wired link to the video processing engine 250. In some embodiments, some or all data from one or plural medical instruments is received over a local area network (LAN) or wide area network (WAN) via an internet communication modem or board 285. In some embodiments, communication between the inventive integration system 100 and one or plural medical instruments is established via a universal serial bus (USB) link. It will be appreciated that communication between the integration system 100 and medical instruments can comprise any one or a combination of communication methods, e.g., wired links, wireless links, LAN or WAN links, USB, HPIB, GPIB, RS-232, RS-485, IEEE 1394, IEEE 802, etc. In various embodiments, control of one or plural medical instruments in communication with the integration system 100 is asserted over a communication link, e.g., an applet passed over a LAN or WAN link, or instructions passed over a wired, wireless link, or USB link. In various embodiments, the integration system 100 provides a variety of communication ports or jacks for the addition of different types of peripheral equipment to the system 100, e.g., printers, chart recorders, video cameras, remote hard drives, remote memory, audio equipment, etc.

In certain embodiments, data from any remote-control apparatus is transmitted wirelessly and received by the wireless modem or communication board 290. Remote-control data received wirelessly can include gesture-based or motion-based control data, voice-recognition control data, image data, etc.

In certain embodiments, the integration system 100 provides for native control of one or plural of the medical instruments in communication with the system 100. For example, a medical instrument can be controlled by input from a system control console 102 or from the instrument's native controls 150, so that a team member can input data directly at an instrument. In some embodiments, the instrument's native controls 150 can be locked out or disabled for a period of time, so that control of the instrument can only be accepted through the integration system 100. In some embodiments, one or plural selected instruments' native controls can be disabled and other instruments' native controls allowed to accept input commands. In some embodiments, control of a selected group of instruments is enabled at one control console and can be locked out of all other control consoles as well as native controls for the selected instruments.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

The section headings used herein are for organizational purposes only and are not to be construed as limiting the subject matter described in any way.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. For example, the present teachings are directed primarily to medical applications, such as complex surgical procedures. However, it will be appreciated that the inventive integration system can be useful for non-medical applications, e.g., investment and market monitoring, manufacturing and process plant monitoring, surveillance (e.g., at casinos), navigating a ship/airplane/space shuttle/train, and the like.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A method comprising:
receiving, by a first computing device, a wireless signal associated with a second computing device;
determining, by the first computing device, an identifier of the second computing device based at least in part on information in the wireless signal;
determining, by the first computing device, based at least in part on the identifier of the second computing device, a window in a display configuration, the window configured to display data from the second computing device;
receiving, by the first computing device, the data from the second computing device; and
displaying, by the first computing device, the data in the window in the display configuration.

2. The method of claim 1, wherein receiving the wireless signal comprises:
detecting, by the first computing device, at least one of a radio frequency identification signal, a Wi-Fi signal, a Bluetooth signal, an infrared signal, and an ultrawideband signal from the second computing device.

3. The method of claim 1, wherein receiving the wireless signal comprises:
receiving, by the first computing device, a wireless signal from a telecommunications network indicating the second computing device is proximate to the first computing device.

4. The method of claim 1, wherein determining the identifier of the second computing device comprises:
determining, by the first computing device, an identification number of the second computing device from the information in the wireless signal.

5. The method of claim 4, wherein determining the identifier of the second computing device further comprises:
determining, by the first computing device, a type of device based at least in part on the identification number.

6. The method of claim 5, wherein determining the type of device based at least in part on the identification number comprises:
retrieving, by the first computing device, an entry from a look-up table based at least in part on the identification number, the entry including the type of device corresponding to the identification number.

7. The method of claim 1, wherein determining the window in the display configuration comprises:
determining, by the first computing device, an inactive window in the display configuration;
selecting, by the first computing device, the inactive window for the second computing device.

8. The method of claim 1, wherein determining the window in the display configuration comprises:
determining, by the first computing device, a priority level of the second computing device based at least in part on the identifier of the second computing device;
determining, by the first computing device, a window in the display configuration corresponding to the priority level of the second computing device; and
selecting, by the first computing device, the window in the display configuration corresponding to the priority level of the second computing device.

9. The method of claim 8, wherein determining the priority level of the second computing device based at least in part on the identifier comprises:
retrieving, by the first computing device, an entry from a look-up table based at least in part on the identifier, the entry including the priority level corresponding to the identifier of the second computing device.

10. The method of claim 8, wherein determining the priority level of the second computing device based at least in part on the identifier comprises:
determining, by the first computing device, a type of device based at least in part on the identifier of the second computing device; and
determining, by the first computing device, the priority level based at least in part on the type of device.

11. The method of claim 10, wherein determining the type of device based at least in part on the identifier of the second computing device comprises:
determining, by the first computing device, that an identifier of the second computing device corresponds to at least one of an x-ray machine, an x-ray image intensifier, an ultrasound machine, a hemodynamic system, and a c-arm.

12. The method of claim 10, wherein determining the priority level based at least in part on the type of device comprises:
retrieving, by the first computing device, an entry from a look-up table based at least in part on the type of device, the entry including the priority level of the type of device.

13. The method of claim 8, wherein determining the window in the display configuration corresponding to the priority level of the second computing device comprises:
comparing, by the first computing device, the priority level of the second computing device with priority levels of a plurality of computing devices associated with windows in the display configuration; and
determining, by the first computing device, a ranking of the second computing device among the plurality of computing devices associated with the windows in the display configuration.

14. The method of claim 13, wherein selecting the window in the display configuration corresponding to the priority level of the second computing device comprises:
selecting, by the first computing device, the window according to the ranking of the second computing device among the plurality of computing devices associated with the windows in the display configuration.

15. The method of claim 1, wherein determining the window in the display configuration based at least in part on the identifier of the second computing device comprises:
selecting, by the first computing device, a display configuration with windows to display data received from a plurality of computing devices in communication with the first computing device and the data from the second computing device;
determining, by the first computing device, a ranking of the second computing device among the plurality of computing devices in communication with the first computing device; and
selecting, by the first computing device, the window in the display configuration according to the ranking of the second computing device among the plurality of computing devices in communication with the first computing device.

16. The method of claim 1, wherein receiving the data from the second computing device comprises:
receiving the data via the wireless signal from the second computing device.

17. The method of claim 1, wherein receiving the data from the second computing device comprises:
receiving the data via a second wireless signal from the second computing device.

18. The method of claim 1, wherein receiving the data from the second computing device comprises:
sending, by the first computing device, a request for the data in a first data format; and
receiving, by the first computing device, the data in the first data format from the second computing device.

19. A method comprising:
detecting, by a first computing device, a touch input on an area of a touchscreen;
determining, by the first computing device, an application corresponding to the area of the touchscreen that received the touch input;
determining, by the first computing device, an instruction corresponding to the touch input based at least in part on the application; and
applying, by the first computing device, the instruction to the application.

20. The method of claim 19, wherein detecting the touch input on the area of the touchscreen comprises:
determining, by the first computing device, a first pair of coordinates on the touchscreen corresponding to a beginning of the touch input; and
determining, by the first computing device, a second pair of coordinates on the touchscreen corresponding to an end of the touch input.

21. The method of claim 19, wherein detecting the touch input on the area of the touchscreen comprises:
determining, by the first computing device, a first pair of coordinates on the touchscreen corresponding to a beginning of a first subpart of the touch input;
determining, by the first computing device, a second pair of coordinates on the touchscreen corresponding to an end of the first subpart of the touch input;
determining, by the first computing device, a third pair of coordinates on the touchscreen corresponding to a beginning of a second subpart of the touch input; and
determining, by the first computing device, a fourth pair of coordinates on the touchscreen corresponding to an end of the second subpart of the touch input.

22. The method of claim 19, wherein detecting the touch input on the area of the touchscreen comprises:
determining, by the first computing device, a difference between a temporal metric of a first pair of coordinates on the touchscreen and a temporal metric of a second pair of coordinates on the touchscreen;
determining, by the first computing device, that the difference exceeds the timing threshold;
after determining that the difference exceeds the timing threshold:
associating, by the first computing device, the first pair of coordinates with a first grouping associated with a first subpart of the touch input, and
associating, by the first computing device, the second pair of coordinates with a second grouping associated with a second subpart of the touch input.

23. The method of claim 19, wherein detecting the touch input on the area of the touchscreen comprises:
determining, by the first computing device, a difference between a location of a first pair of coordinates on the touchscreen and a location of a second pair of coordinates on the touchscreen;
determining, by the first computing device, that the difference exceeds a spatial threshold;
after determining that the difference exceeds the spatial threshold:
associating, by the first computing device, the first pair of coordinates with a first grouping associated with a first subpart of the touch input when the difference exceeds the spatial threshold, and
associating, by the first computing device, the second pair of coordinates with a second grouping associated with a second subpart of the touch input when the difference exceeds the spatial threshold.

24. The method of claim 19, wherein determining the application corresponding to the area of the touchscreen that received the touch input comprises:
matching, by the first computing device, a first pair of coordinates associated with the touch input with a window on a display configuration; and
determining, by the first computing device, the application associated with the window.

25. The method of claim 19, wherein determining the application corresponding to the area of the touchscreen that received the touch input comprises:
determining, by the first computing device, the application whose data is being displayed at a first pair of coordinates associated with the touch input.

26. The method of claim 19, wherein determining the instruction corresponding to the touch input based at least in part on the application comprises:
determining, by the first computing device, a type of user gesture based on the touch input.

27. The method of claim 26, wherein determining the type of user gesture comprises:
determining, by the first computing device, the type of user gesture is at least one of a tap, a double tap, a swipe, a pinch, and a spread.

28. The method of claim 19, wherein determining the instruction corresponding to the touch input based at least in part on the application comprises:
retrieving, by the first computing device, an entry from a look-up table based on a type of user gesture corresponding to the touch input and the application, wherein the entry includes the command associated with the user gesture for the application.

29. A method comprising:
detecting, by a first computing device, a signal from a marking device proximate to a display;
determining, by the first computing device, an instruction associated with the signal from the marking device; and
applying, by the first computing device, the instruction to the display.

30. The method of claim 29, wherein detecting the signal from the marking device comprises:
detecting, by an optical sensor of the first computing device, an optical signal from the marking device.

31. The method of claim 29, wherein detecting the signal from the marking device comprises:
detecting, by a magnetic sensor of the first computing device, a magnetic signal from the marking device.

32. The method of claim 29, wherein detecting the signal from the marking device comprises:
detecting, by the first computing device, a wireless signal including an identification number of the marking device.

33. The method of claim 29, wherein determining the instruction associated with the signal from the marking device comprises:
determining, by the first computing device, an instruction to mark an area of the display corresponding to sensors detecting the signal from the marking device.

34. The method of claim 33, wherein determining the instruction associated with the signal from the marking device further comprises:
determining, by the first computing device, a color associated with the marking device based at least in part on an identification number of the marking device.

35. The method of claim 33, wherein determining the instruction associated with the signal from the marking device further comprises:
determining, by the first computing device, a period of time for markings associated with the marking device to be displayed on the display.

36. The method of claim 35, wherein determining the period of time for markings associated with the marking device to be displayed on the display comprises:
determining the period of time based at least in part on an identification number of the marking device.

37. The method of claim 35, wherein determining the period of time for markings associated with the marking device to be displayed on the display comprises:
determining to display the markings between about 2 and about 10 seconds.

38. The method of claim 35, wherein determining the period of time for markings associated with the marking device to be displayed on the display comprises:
determining to display the markings until the first computing device receives an instruction to erase the markings.

39. The method of claim 29, wherein applying the instruction to the display comprises:
writing, by the first computing device, markings to an area of the frame buffer corresponding to the area of the display corresponding to sensors detecting the signal from the marking device.

40. A method comprising:
detecting, by a central processing station, a first wireless signal from a first medical instrument indicating that the first medical instrument is proximate to the central processing station, wherein the first wireless signal comprises at least one of a radio frequency identification signal, a Wi-Fi signal, a Bluetooth signal, an infrared signal, and an ultrawideband signal from a first medical instrument;
determining, by the central processing station, a first identifier associated with the first medical instrument from the first wireless signal;
determining, by the central processing station, a type of device based at least in part on the first identifier;
determining, by the central processing station, a first window in a first display configuration based at least in part on the type of device, wherein the first window displays first data from the first medical instrument;
receiving, by the central processing station, the first data from the first medical instrument;
displaying, by the central processing station, the first data in the first window in the first display configuration;
detecting, by the central processing station, a second wireless signal from a telecommunications network indicating that a second medical instrument is proximate to the central processing station, wherein the second wireless signal comprises a 4G signal;
determining, by the central processing station, a second identifier associated with the second medical instrument from the second wireless signal, wherein the second identifier is an identification number;
determining, by the central processing station, a second display configuration, the second display configuration configured to display at least the first data from the first medical instrument and second data from the second medical instrument;
displaying, by the central processing station, the second display configuration;
determining, by the central processing station, a second window in the second display configuration based at least in part on the type of device;
displaying, by the central processing station, the first data from the first medical instrument in the second window;
determining, by the central processing station, a third window in the second display configuration based on the identification number of the second medical instrument;
receiving, by the central processing station, the second data from the second medical instrument; and
displaying, by the central processing station, the second data in the third window in the second display configuration.

41. A method comprising:
determining, by a central processing station, a first pair of coordinates on a touchscreen and a first time, the first pair of coordinates and the first time associated with a beginning of a touch input; and
determining, by the central processing station, a second pair of coordinates on the touchscreen and a second time, the second pair of coordinates and the second time associated with an end of the touch input;
determining, by the central processing station, a type of user gesture associated with the touch input based at least in part on the first pair of coordinates, the first time, the second pair of coordinates, and the second time;
determining, by the central processing station, an application associated with at least the first pair of coordinates and the second pair of coordinates on the touchscreen;
determining, by the central processing station, an instruction based at least in part on the user gesture and the application;
applying, by the central processing station, the instruction to the application.

42. A method comprising:
detecting a first signal from a marking device;
determining, by a central processing station, a first pair of coordinates on a display associated with the signal from the marking device;
determining, by a central processing station in communication with the display, an identifier associated with the marking device;
determining, by the central processing station, a color associated with the identifier;
determining, by the central processing station, an amount of time that an input from the marking device shall be displayed on the display, the amount of time associated with the identifier; and
sending, by the central processing station, a second signal to the display to cause the color to be displayed at the first pair of coordinates on the display.

43. The method of claim 42, wherein the identifier comprises an identification number.
